(19) United States
(12) Patent Application Publication
(10) Pub. No.: US 2020/0279110 A1
(43) Pub. Date: Sep. 3, 2020

(54) INFORMATION PROCESSING APPARATUS, INFORMATION PROCESSING METHOD, AND PROGRAM

(71) Applicant: SONY CORPORATION, TOKYO (JP)

(72) Inventor: TAKANOBU OMATA, KANAGAWA (JP)

(21) Appl. No.: 16/645,028

(22) PCT Filed: Aug. 6, 2018
(86) PCT No.: PCT/JP2018/029336

§ 371 Date: Mar. 6, 2020

(30) Foreign Application Priority Data
Sep. 15, 2017 (JP) 2017-178209

(51) Int. Cl. G06K 9/00; G06F 3/01; G06F 3/0481; G06F 3/16; G02B 27/01; G06T 7/73; G06T 19/00

(52) U.S. Cl. CPC G06K 9/00671; G06F 3/011; G06F 3/04815; G06T 19/006; G02B 27/0172; G06T 7/74; G06F 3/167

(57) ABSTRACT

[Problem] To provide an information processing apparatus, an information processing method, and a program capable of preventing a target object outside a field of view from being overlooked. [Solution] An information processing apparatus includes: a control unit that extracts a target object and a basic point object from an image corresponding to a user's field of view, stores basic point object information on the basic point object in a storage unit, determines whether the target object is included in an image corresponding to a current field of view when the user is guided to the target object, and performs a process of presenting a position of the target object using the stored basic point object information when the target object is not included in an image corresponding to the current field of view.

### FIELD

The present disclosure relates to an information processing apparatus, an information processing method, and a program.

### BACKGROUND

Conventionally, a technology for appropriately presenting information on user guidance or leading to a user using an information processing apparatus has been proposed.

For example, Patent Literature 1 below discloses an advertisement presentation server that detects a line-of-sight direction of a customer in a store, judges information on a product being gazed from the line-of-sight direction, determines attributes of the customer in the store, acquires the information on the product based on both the judged results, and reads the corresponding content and play the content using a signage apparatus.

In addition, Patent Literature 2 below discloses a head-mounted display system that filters augmented reality (AR) objects superimposed and displayed in real space according to priorities such as mode, preference, and a proximity level.

### CITATION LIST

### Patent Literature

Patent Literature 1: JP 2016-38877 A

Patent Literature 2: JP 2016-507833 A

### SUMMARY

### Technical Problem

However, in the conventional technology, it is effective when an object that the user is likely to be interested in enters the user's line-of-sight direction, and it is difficult for a system side to notify the user of an object what does not enter the user's line-of-sight direction. As a result, the user may overlook the object which the user is likely to interest in.

Therefore, the present disclosure proposes an information processing apparatus, an information processing method, and a program capable of preventing a target object outside a field of view from being overlooked.

### Solution to Problem

According to the present disclosure, an information processing apparatus is provided that includes: a control unit that extracts a target object and a basic point object from an image corresponding to a user's field of view, stores basic point object information on the basic point object in a storage unit, determines whether the target object is included in an image corresponding to a current field of view when the user is guided to the target object, and performs a process of presenting a position of the target object using the stored basic point object information when the target object is not included in an image corresponding to the current field of view.

According to the present disclosure, an information processing method is provided that includes: extracting, by a processor, a target object and a basic point object from an image corresponding to a user's field of view; storing, by the processor, basic point object information on the basic point object in a storage unit; judging, by the processor, whether the target object is included in an image corresponding to a current field of view when guiding the user to the target object; and performing, by the processor, a process of presenting the position of the target object using the stored basic point object information when the target object is not included in the image corresponding to the current field of view.

According to the present disclosure, a program is provided that allows a computer to function as a control that extracts a target object and a basic point object from an image corresponding to a user's field of view, stores basic point object information on the basic point object in a storage unit, judges whether the target object is included in an image corresponding to a current field of view when guiding the user to the target object, and performs a process of presenting the position of the target object using the stored basic point object information when the target object is not included in the image corresponding to the current field of view.

### Advantageous Effects of Invention

As described above, according to the present disclosure, it is possible to prevent the target object outside the field of view from being overlooked.

It is noted that the above effects are not necessarily limited, and, along with or instead of the above effects, any of the effects described in the present specification or other effects which can be understood from the present specification may be exhibited.

### BRIEF DESCRIPTION OF DRAWINGS

FIG. 1 is a diagram for describing an outline of an information processing terminal used in an information processing system according to an embodiment of the present disclosure.

FIG. 2 is a block diagram illustrating a configuration example of an information processing system according to the present embodiment.

FIG. 3 is a block diagram illustrating a configuration example of an information processing terminal according to the present embodiment.

FIG. 4 is a block diagram illustrating a configuration example of an information processing server according to the present embodiment.

FIG. 5 is a block diagram illustrating a configuration example of a response information generation unit of an information processing server according to a first embodiment.

FIG. 6 is a diagram for explaining an example of an information processing terminal according to a first embodiment.

FIG. 7 is a flowchart illustrating an operation process of collecting request information according to the first embodiment.

FIG. 8 is a flowchart illustrating an operation process of notifying request information according to the first embodiment.

FIG. 9 is a diagram illustrating an example of displaying as an AR image of a purchase request item according to the first embodiment.

FIG. 10 is a diagram illustrating an example of presenting the request information according to the first embodiment on a smartphone screen.

FIG. 11 is a block diagram illustrating a configuration example of a response information generation unit of an information processing server according to a second embodiment.

FIG. 12 is a flowchart illustrating a process of registering a target object and a basic point object according to the second embodiment.

FIG. 13 is a diagram for explaining a situation of a user according to the second embodiment.

FIG. 14 is a diagram illustrating an example of extracting the target object and the basic point object from an image corresponding to a field of view of a user according to the second embodiment.

FIG. 15 is a flowchart illustrating a process of guidance to the target object according to the second embodiment.

FIG. 16 is a diagram illustrating an example of marking AR on the target object according to the second embodiment.

FIG. 17 is a block diagram illustrating a hardware configuration example of the information processing terminal and the information processing server according to the embodiment of the present disclosure.

### DESCRIPTION OF EMBODIMENTS

Hereinafter, preferred embodiments of the present disclosure will be described in detail with reference to the accompanying drawings. In addition, in this specification and drawings, components which have the substantially same function configuration are denoted by the same reference numerals, and therefore duplicate description thereof will be omitted.

In addition, the description will be made in the following order.

1. Overview

2. Configuration

2-1. System Configuration Example

2-2. Configuration of Information Processing Terminal 1

2-3. Configuration of Information Processing Server 2

3. First Embodiment (Product Purchase Request)

3-1. Configuration

3-2. Operation Process

(3-2-1. Process of Collecting Request Information)

(3-2-2. Process of Notifying Request Information)

3-3. Effect

4. Second Embodiment (Guidance to Target Object)

4-1. Configuration

4-2. Operation Process

(4-2-1. Process of Registering Target Object and Basic Point Object)

(4-2-2. Process of Guidance to Target Object)

4-3. Effect

5. Hardware Configuration

6. Summary

### 1. Overview

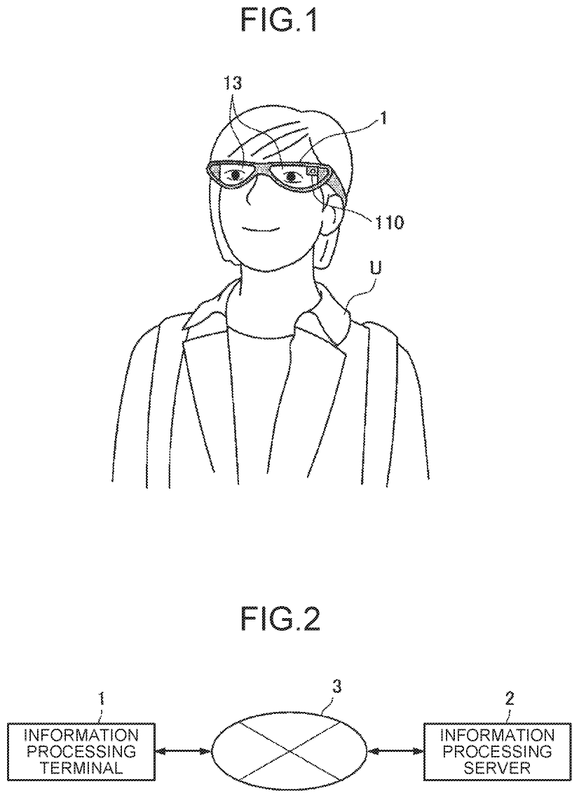

FIG. 1 is a diagram illustrating an overview of an information processing terminal 1 used in an information processing system according to an embodiment of the present disclosure. As illustrated in FIG. 1, the information processing terminal 1 used in the information processing system according to the present embodiment is realized by, for example, a glasses-type head mounted display (HMD) attached to a head of a user U. A display unit 13 corresponding to a spectacle lens portion located in front of eyes of the user U when worn may be transmissive or non-transmissive. The information processing terminal 1 can present a virtual object in a field of view of the user U by displaying the virtual object on the display unit 13. Further, the HMD that is an example of the information processing terminal 1 is not limited to those that present an image to both eyes, and may be those that present an image only to one eye. For example, the HMD may be a one-eye type provided with the display unit 13 that presents an image to one eye.

In addition, the information processing terminal 1 is provided with an outward camera 110 that captures a line-of-sight direction of the user U, that is, a field of view of a user U when worn. Further, although not illustrated in FIG. 1, the information processing terminal 1 is provided with various sensors such as an inward camera and a microphone (hereinafter referred to as “mike”) that captures the eyes of the user U when worn. A plurality of outward cameras 110 and inward cameras may be provided.

Further, a shape of the information processing terminal 1 is not limited to the example illustrated in FIG. 1. For example, the information processing terminal 1 may be a headband-type (type that is worn with a band that goes around the entire circumference of the head. In addition, there may also be a type provided with a band passing through a crown as well as a temporal region) HMD or a helmet-type (a visor portion of a helmet corresponds to a display) HMD. In addition, the information processing terminal 1 may be realized by wearable devices such as a wristband type (for example, including a case with or without a smart watch display), a headphone type (without a display), or a neckphone type (including a case with or without a neck type display).

Here, for example, when the display unit 13 is a transmissive type, the information processing terminal 1 can perform display control to dispose a virtual object in a real space based on information (an image corresponding to a field of view of a user) on the real space (for example, a field of view of a user) obtained by photographing with the outward camera 110.

However, it is possible for a user to be aware of an object that is in the field of view of the user U by the display control to dispose the virtual object in the real space, but it is difficult for the user to be aware of an object that is outside the field of view of the user U.

Therefore, in the information processing system according to the present embodiment, it is possible to prevent a target object outside the field of view from being overlooked by guidance to the target object using a basic point object that can easily attract user's visual attention.

The target object outside the field of view is assumed to be a real object that the user is likely to be interested in, a predetermined real object that should be notified to the user, or the like.

Further, the information processing terminal 1 according to the present embodiment can notify the user of a product purchase request from another user, for example. As described above, for example, when the information processing terminal 1 is realized by a glasses-type HMD and a user wears the glasses-type HMD every day, convenience can be further enhanced by allowing family, or the like at home or other places to perform a purchase request at the appropriate time while the user is out.

Hereinafter, in the present specification, first, a basic configuration of an information processing system according to the present embodiment will be described, and then each function of the information processing system according to the present embodiment will be described in detail with reference to examples.

### 2. Configuration

### 2-1. System Configuration Example

Next, a configuration example of the information processing system according to the present embodiment will be described. FIG. 2 is a block diagram illustrating a configuration example of the information processing system according to the present embodiment. Referring to FIG. 2, the information processing system according to the present embodiment includes an information processing terminal 1 and an information processing server 2. The information processing terminal 1 and the information processing server 2 are connected to each other via a network 3 so that the information processing terminal 1 and the information processing server 2 can communicate with each other.

(Information Processing Terminal 1)

The information processing terminal 1 according to the present embodiment is an information processing apparatus having a function of guiding a user to a target object based on control by the information processing server 2. Further, the information processing terminal 1 according to the present embodiment may have a function of collecting various information on user behavior.

(Information Processing Server 2)

The information processing server 2 according to the present embodiment is an information processing apparatus having a function of controlling guidance to a target object by the information processing terminal 1. Specifically, for example, the information processing server 2 has an agent function of interacting with a user, and can guide a target object as one of information presentations by the agent. The agent function is a function of assisting the user through a natural language, and is sometimes called a digital assistant function, an artificial intelligence (AI) assistant, an intelligent personal assistant, or the like.

(Network 3)

The network 3 has a function of connecting the information processing terminal 1 and the information processing server 2. The network 3 may include a public line network such as the Internet, a telephone line network, a satellite communication network, various local area networks (LANs) including Ethernet (registered trademark), a wide area network (WAN), and the like. The network 3 may include dedicated line networks such as an internet protocol-virtual private network (IP-VPN). The network 3 may include wireless communication networks such as Wi-Fi (registered trademark) or Bluetooth (registered trademark).

The system configuration example of the information processing system according to the present embodiment has been described above. Note that the above-described configuration described with reference to FIG. 2 is merely an example, and the configuration of the information processing system according to the present embodiment is not limited to the example. For example, the functions of the information processing terminal 1 and the information processing server 2 according to the present embodiment may be realized by a single device. The configuration of the information processing system according to the present embodiment can be flexibly modified according to specifications and operations.

### 2-2. Configuration of Information Processing Terminal 1

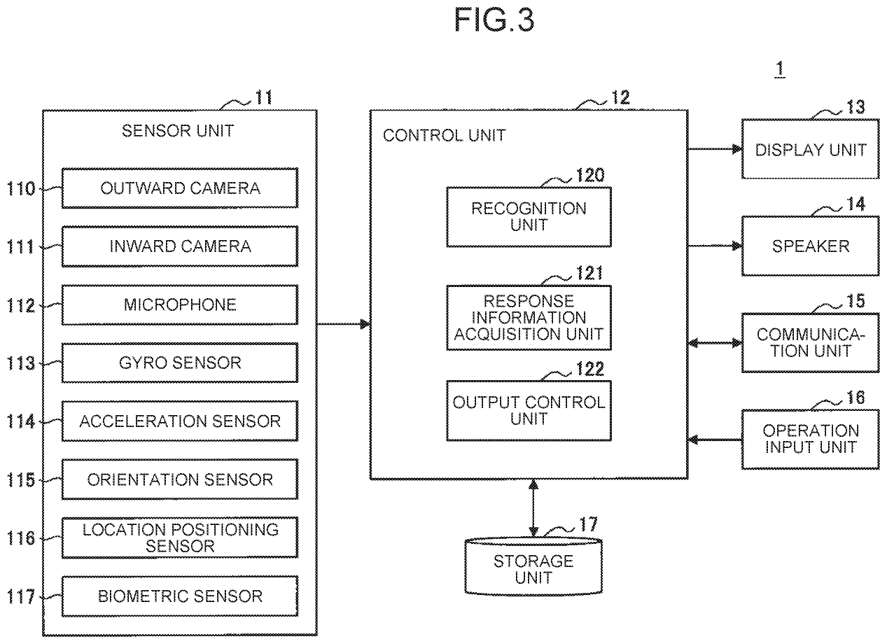

FIG. 3 is a block diagram illustrating an example of the configuration of the information processing terminal 1 according to the present embodiment. FIG. 3 is a block diagram illustrating a configuration example of the information processing terminal 1 according to the present embodiment. As illustrated in FIG. 3, the information processing terminal 1 includes a sensor unit 11, a control unit 12, a display unit 13, a speaker 14, a communication unit 15, an operation input unit 16, and a storage unit 17.

(Sensor Unit 11)

The sensor unit 11 has a function of acquiring various types of information on the user or the surrounding environment. For example, the sensor unit 11 includes an outward camera 110, an inward camera 111, a mike 112, a gyro sensor 113, an acceleration sensor 114, an orientation sensor 115, a location positioning unit 116, and a biometric sensor 117. In addition, a specific example of the sensor unit 11 mentioned herein is one example, and the present embodiment is not limited thereto. In addition, each sensor may be plural.

Further, the specific examples of the sensor unit 11 illustrated in FIG. 3 is given as preferable examples, but it is not essential to have all of these examples. For example, the configuration may include a part of the specific examples of the sensor unit 11 illustrated in FIG. 3 such as the outward camera 110, the acceleration sensor 114, and the location positioning unit 116, or may include another sensor.

The outward camera 110 and the inward camera 111 each include a lens system that includes an imaging lens, an aperture, a zoom lens, a focus lens, and the like, a drive system that causes the lens system to perform a focus operation and a zoom operation, a solid-state image device array that photoelectrically converts imaging light obtained by the lens system to generate an imaging signal, and the like. The solid-state image device array may be realized by, for example, a charge coupled device (CCD) sensor array or a complementary metal oxide semiconductor (CMOS) sensor array.

In the present embodiment, it is preferable that the outward camera 110 is set with an angle of view and an orientation so as to capture an area corresponding to a field of view of a user in a real space.

The mike 112 collects a user's voice and surrounding environmental sounds and outputs the user's voice and surrounding environmental sounds to the control unit 12 as voice data.

The gyro sensor 113 is realized by, for example, a three-axis gyro sensor, and detects an angular velocity (rotational speed).

The acceleration sensor 114 is realized by, for example, a three-axis acceleration sensor (also referred to as a G sensor), and detects acceleration during movement.

The orientation sensor 115 is realized by, for example, a three-axis geomagnetic sensor (compass), and detects an absolute direction (azimuth).

The location positioning unit 116 has a function of detecting the current position of the information processing terminal 1 based on a signal acquired from the outside. Specifically, for example, the location positioning unit 116 is realized by a global positioning system (GPS) positioning unit, and receives a radio wave from a GPS satellite, detects a location where the information processing terminal 1 exists, and outputs the detected location information to the control unit 12. In addition to the GPS, the location positioning unit 116 may detect the location by transmission and reception to and from, for example, Wi-Fi (registered trademark), Bluetooth (registered trademark), mobile phone, PHS, smartphone and the like, or near field communication.

The biometric sensor 117 detects biometric information on the user. Specifically, for example, a heart rate, a body temperature, sweating, a blood pressure, sweating, a pulse, breathing, blinking, an eye movement, a gaze time, a pupil size, a blood pressure, a brain wave, a body movement, a body position, a skin temperature, a skin electrical resistance, microvibration (MV), myoelectric potential, or SPO2 (blood oxygen saturation)), and the like can be detected.

(Control Unit 12)

The control unit 12 functions as an arithmetic processing device and a control device, and controls the overall operation of the information processing terminal 1 according to various programs. The control unit 12 is realized by an electronic circuit such as a central processing unit (CPU) or a microprocessor, for example. The control unit 12 may include a read only memory (ROM) that stores programs to be used, calculation parameters, and the like, and a random access memory (RAM) that temporarily stores parameters varying as appropriate.

The control unit 12 according to the present embodiment controls, for example, starting and stopping of each component. Further, the control unit 12 can input a control signal generated by the information processing server 2 to the display unit 13 or the speaker 14.

Further, the control unit 12 according to the present embodiment may function as a recognition unit 120, a response information acquisition unit 121, and an output control unit 122, as illustrated in FIG. 3.

Recognition Unit 120

The recognition unit 120 has a function of recognizing (including detection) information on the user or information on the surrounding situation using various sensor information sensed by the sensor unit 11. For example, the recognition unit 120 can perform voice recognition based on the user's utterance sensed by the sensor unit 11, and can recognize a request from the user and a user's response. The recognition unit 120 can recognize the user's behavior from the image and voice sensed by the sensor unit 11, position information, motion information, and the like. The recognition unit 120 outputs the recognition result to the response information acquisition unit 121.

Note that the level of recognition processing performed by the recognition unit 120 according to the present embodiment may be simple, and advanced recognition processing may be performed by an external device, for example, the information processing server 2. That is, by appropriately using the recognition unit 120 of the information processing terminal 1 and a recognition unit 201 of the information processing server 2, it is possible to reduce a burden due to the distribution of processing, improve real-time properties, and ensure security. Alternatively, the information processing terminal 1 may not include the recognition unit 120, and all recognition processes may be performed by an external device, for example, the information processing server 2. Alternatively, the recognition unit 120 according to the present embodiment may have a function equivalent to that of the recognition unit 201 of the information processing server 2 described later.

Response Information Acquisition Unit 121

Based on the recognition result by the recognition unit 120, the response information acquisition unit 121 acquires information to be presented to the user (herein referred to as response information) and outputs the information to the output control unit 122. The response information includes a wide variety of output information such as an answer to the user's request, guidance information corresponding to the user's behavior, notification of a predetermined target object, interaction with the user's murmur, dialogue with the user according to the situation. The response information may be, for example, voice data, image data (still image, moving image, virtual object (also referred to as AR image)).

The response information may be acquired from the storage unit 17 or may be acquired from the information processing server 2 via the communication unit 15. For example, the response information acquisition unit 121 may transmit the recognition result by the recognition unit 120 from the communication unit 15 to the information processing server 2 and acquire response information generated based on the recognition result in the information processing server 2.

Further, the response information acquisition unit 121 is not limited to the case based on the recognition result by the recognition unit 120, and may acquire the response information based on various sensor information sensed by the sensor unit 11. For example, the response information acquisition unit 121 may transmit various sensor information sensed by the sensor unit 11 from the communication unit 15 to the information processing server 2, and acquire response information generated based on recognition processing based on the various sensor information performed in the information processing server 2.

Alternatively, the response information acquisition unit 121 may acquire response information based on the recognition result and various sensor information. For example, the response information acquisition unit 121 may transmit a recognition result and various sensor information from the communication unit 15 to the information processing server 2 and acquire the response information generated based on the recognition result and the various sensor information in the information processing server 2.

Output Control Unit 122

The output control unit 122 performs control to output various types of information from the display unit 13 or the speaker 14. The output control unit 122 according to the present embodiment controls, for example, to output the response information acquired by the response information acquisition unit 121 in either voice or display, or both voice and display. For example, the output control unit 122 controls the voice output from the speaker 14 when the response information is voice data, and executes display control related to the display unit 13 in the case of a virtual object so as to be within the field of view of the user.

(Display Unit 13)

The display unit 13 is realized by, for example, a lens unit (an example of a transmissive display unit) that performs display using, for example, a hologram optical technique, a liquid crystal display (LCD) device, an organic light emitting diode (OLED) device, and the like. In addition, the display unit 13 may be a transmissive type, a transflective type, or a non-transmissive type.

(Speaker 14)

The speaker 14 plays a voice signal according to the control of the control unit 12.

(Communication Unit 15)

The communication unit 15 is a communication module for transmitting and receiving data to and from other devices in a wired/wireless manner. The communication unit 15 performs wireless communication with external devices directly or via a network access point by, for example, a wired local area network (LAN), a wireless LAN, wireless fidelity (Wi-Fi (registered trademark)), infrared communication, Bluetooth (registered trademark), near field/non-contact communication, a mobile communication network (long term evolution (LTE)), 3rd (3G) generation mobile communication system), and the like.

(Operation Input Unit 16)

The operation input unit 16 is realized by an operation member having a physical structure such as a switch, a button, or a lever.

(Storage Unit 17)

The storage unit 17 is realized by a read only memory (ROM) that stores programs and calculation parameters used for the processing of the control unit 12 described above, and a random access memory (RAM) that temporarily stores parameters varying as appropriate. For example, the various sensor information, the recognition results, the response information, the user information, and the like may be stored in the storage unit 17 according to the present embodiment.

The configuration of the information processing terminal 1 according to the present embodiment has been specifically described above. Note that the above-described configuration described with reference to FIG. 3 is merely an example, and the functional configuration of the information processing terminal 1 according to the present embodiment is not limited to this example. For example, the information processing terminal 1 according to the present embodiment does not necessarily have all of the configurations illustrated in FIG. 3. The information processing terminal 1 can be configured not to include the mike 112, the biometric sensor 117, and the like. In addition, the information processing terminal 1 may be configured by a plurality of communication-connected devices (a wearable device separately worn by a user, a device attached to glasses, and the like). Further, for example, at least a part of the functions of the control unit 12 of the information processing terminal 1 may exist in another device connected via the communication unit 15. The functional configuration of the information processing terminal 1 according to the present embodiment can be flexibly modified according to specifications and operations.

### 2-3. Configuration of Information Processing Server 2

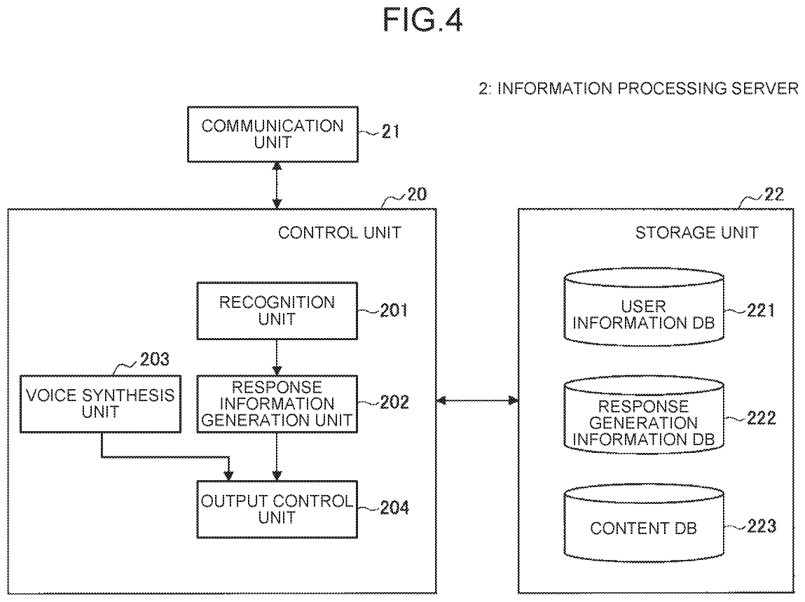

FIG. 4 is a block diagram illustrating an example of the configuration of the information processing server 2 according to the present embodiment. As illustrated in FIG. 4, the information processing server 2 (an example of an information processing apparatus) includes a control unit 20, a communication unit 21, and a storage unit 22.

(Control Unit 20)

The control unit 20 functions as an arithmetic processing device and a control device, and controls the overall operation of the information processing server 2 according to various programs. The control unit 20 is realized by an electronic circuit such as a central processing unit (CPU) or a microprocessor. In addition, the control unit 20 may include a read only memory (ROM) that stores programs to be used, calculation parameters, and the like, and a random access memory (RAM) that temporarily stores parameters varying as appropriate.

Further, the control unit 20 according to the present embodiment also functions as a recognition unit 201, a response information generation unit 202, a voice synthesis unit 203, and an output control unit 204, as illustrated in FIG. 4.

Recognition Unit 201

The recognition unit 201 has a function of recognizing (including detecting) information on a user or information on a surrounding situation based on various sensor information received from the information processing terminal 1.

For example, the recognition unit 201 can perform recognition of a user by comparing a user's utterance or an image collected by the information processing terminal 1 with user's voice characteristics or images stored in a user information DB 221 in advance as recognition of information on the user.

In addition, the recognition unit 201 can recognize the user's behavior based on sound information, an image, and sensor information collected by the information processing terminal 1. For example, the recognition unit 201 can perform voice recognition based on the user's utterance collected by the information processing terminal 1, and can recognize a user's request, instruction, response, or the like. The recognition unit 201 can also recognize a user's hobby, preference, schedule, or the like based on the user's request, instruction, response, or the like. Further, for example, the recognition unit 201 can recognize a state of a user (running, walking, riding a train, eating, sleeping, and the like, where and what he/she are doing) based on the image and sensor information collected by the information processing terminal 1.

Further, for example, the recognition unit 201 may recognize a position and posture of a user's head (including an orientation or inclination of a face with respect to a body), a user's line-of-sight, a user's gazing point, and the like as the recognition related to the user. The recognition unit 201 may detect the user's gazing point based on the user's line-of-sight. For example, when the user's line-of-sight stays in a certain range for a predetermined time or longer, the recognition unit 201 may detect a point (three-dimensional position) ahead of the user's line-of-sight as the gazing point. Note that a method for detecting a user's gazing point by the recognition unit 201 is not limited to this example, and the detection may be performed by various known methods.

Further, the recognition unit 201 may recognize a three-dimensional shape in a field of view of a user as information on the surrounding situation. For example, when the information processing terminal 1 is provided with the plurality of outward cameras 110, the recognition unit 201 may obtain a depth image (distance image) from parallax information and recognize the three-dimensional shape in the field of view of the user. In addition, even when the information processing terminal 1 has only one outward camera 110, the recognition unit 201 recognizes the three-dimensional shape in the field of view of the user from the images acquired in time series.

Further, the recognition unit 201 may detect a real object (object) in the field of view of the user as the information on the surrounding situation. Specifically, the detection of the real object may be realized, for example, by detecting a boundary surface of the real object. In this specification, the “boundary surface” is used as an expression including, for example, a surface between a real object and another real object, or a surface between a space where no real object exists and the real object, and the like. In addition, the boundary surface may be a curved surface. The recognition unit 201 may detect the real object from the image acquired by the outward camera 110, or may detect the boundary surface of the real object based on the recognized three-dimensional shape in the field of view of the user. For example, when the three-dimensional shape in the field of view of the user is expressed as point cloud data, the recognition unit 201 can detect the boundary surface by clustering the point cloud data. Note that the method for detecting a boundary surface by the recognition unit 201 is not limited to this example, and the detection may be performed by various known methods.

Further, the recognition unit 201 may perform the object recognition of the detected real object. An algorithm for object recognition is not particularly limited, but for example, technologies such as general object recognition that recognizes an object by extracting features from an input image and classifying the features by a learned classifier or specific object recognition that extracts features from an input image and judged the extracted features by comparing with a database generated in advance may be used.

The various recognition processes performed by the recognition unit 201 have been described above, but at least a part of the recognition processes may be performed by the recognition unit 120 of the information processing terminal 1 or the external device. For example, the recognition unit 120 of the information processing terminal 1 may perform the recognition of the posture, line-of-sight, and gazing point of the user described above, and the recognition of the three-dimensional shape in the field of view of the user.

In addition, various recognition results recognized by the recognition unit 201 may be stored in the storage unit 22.

Response Information Generation Unit 202

The response information generation unit 202 generates information to be presented to a user in real time based on the information on the user recognized by the recognition unit 201 or the situation around the user. As described above, the “response information” includes a wide variety of output information such as an answer to a user's request, guidance information corresponding to a user's behavior, notification of a predetermined target object, interaction with a user's murmur, dialogue with the user according to the situation.

In addition, when the response information is generated, the response information generation unit 202 may use user information (user profile, behavior history, hobby preferences, schedule, and the like) accumulated in the storage unit 22, response generation information (a response fixed phrase, an answer sentence pattern, and the like corresponding to predetermined keywords), and content (news, weather forecast, moving image, music, game, and the like), and the like, or may use information acquired from an external device (such as another server) communication-connected via the communication unit 21. Note that the generated contents of the specific response information according to the present embodiment will be described in each example described later.

Further, the response information generated by the response information generation unit 202 can be presented to the user by visual expression or auditory expression in the information processing terminal 1. Specifically, the visual expression is an information form that is assumed to be text data, image data (still image, moving image), AR object, or the like and is output using the display unit 13 of the information processing terminal 1. In addition, the auditory expression is voice data output using the speaker 14 of the information processing terminal 1, and an artificial voice is synthesized by the voice synthesis unit 203 described below.

Voice Synthesis Unit 203

The voice synthesis unit 203 has a function of synthesizing artificial voice output from the information processing terminal 1. Specifically, the voice synthesis unit 203 synthesizes an artificial voice corresponding to the response information generated by the response information generation unit 202.

Output Control Unit 204

The output control unit 204 transmits various types of response information such as the synthesized artificial voice or the generated visual information to the information processing terminal 1 and controls the information processing terminal 1 to output the response information.

The control unit 20 according to the present embodiment has been described above. Note that the function of the control unit 20 according to the present embodiment is not limited to the example illustrated in FIG. 4, and the control of various devices (switch ON/OFF, operation control, and the like) or the use of Internet services (Internet shopping, accommodation, reservation of seats, and the like) can also be performed, for example, according to the recognized information on the user or the situation around the user.

(Communication Unit 21)

The communication unit 21 is connected to the network 3 in a wired or wireless manner, and transmits and receives data to and from the external device via the network 3. The communication unit 21 is communication-connected to the network 3 through, for example, a wired/wireless local area network (LAN) or wireless fidelity (Wi-Fi (registered trademark)). Specifically, the communication unit 21 according to the present embodiment receives sound information, image information, and sensor information from the information processing terminal 1. In addition, the communication unit 21 transmits the response information generated by the response information generation unit 202 or the artificial voice (voice data of response information) synthesized by the voice synthesis unit 203 to the information processing terminal 1 according to the control of the output control unit 204.

(Storage Unit 22)

The storage unit 22 is realized by a ROM that stores programs, calculation parameters, or the like used for the processing of the control unit 20, and a RAM that temporarily stores parameters varying as appropriate. For example, the storage unit 22 according to the present embodiment stores a user information database (DB) 221, a response generation information DB 222, and a content DB 223.

The user information DB 221 stores a user profile, a behavior history, a hobby preference, a schedule, and the like. These may be registered in advance, or may be automatically recognized and accumulated by the recognition unit 201 from the user's behavior or dialogue. In addition, the response generation information DB 222 stores an algorithm or the like used when generating response information. For example, the response fixed phrase and the response sentence pattern corresponding to the predetermined keywords are stored.

In addition, the content DB 223 stores content such as news, weather forecast, moving image, music, game, and the like. Such content may be accumulated by periodically acquiring latest information from the outside by the communication unit 21.

The functional configuration example of the information processing server 2 according to the present embodiment has been described above. Note that the above-described functional configuration described with reference to FIG. 4 is merely an example, and the functional configuration of the information processing server 2 according to the present embodiment is not limited to this example. For example, the information processing server 2 does not necessarily have all of the configurations illustrated in FIG. 4. The recognition unit 201, the response information generation unit 202, the voice synthesis unit 203, the output control unit 204, and the storage unit 22 can be provided in another device different from the information processing server 2. The functional configuration of the information processing server 2 according to the present embodiment can be flexibly modified according to specifications or operations.

For example, at least a part of the configuration of the recognition unit 201, the response information generation unit 202, the voice synthesis unit 203, the output control unit 204, and the storage unit 22 may be in an external device, or at least a part of each function of the control unit 20 may be realized by the information processing terminal 1 or the information processing apparatus (for example, a so-called edge server) having a communication distance relatively close to the information processing terminal 1. As described above, it is possible to improve real-time performance, reduce a processing load, and further ensure security by appropriately distributing each configuration of the information processing server 2.

In addition, each configuration of the control unit 20 illustrated in FIG. 4 and the storage unit 22 are all provided in the information processing terminal 1, and the information processing system according to the present embodiment may be executed by the application of the information processing terminal 1.

### 3. First Embodiment

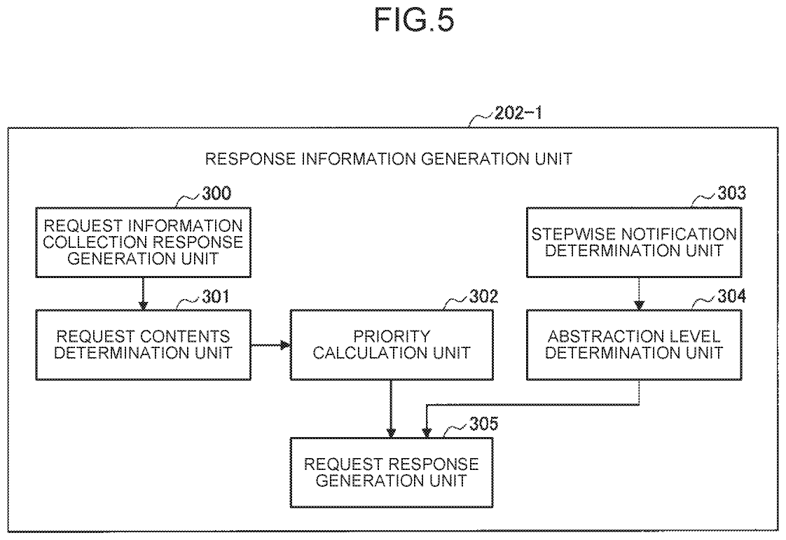

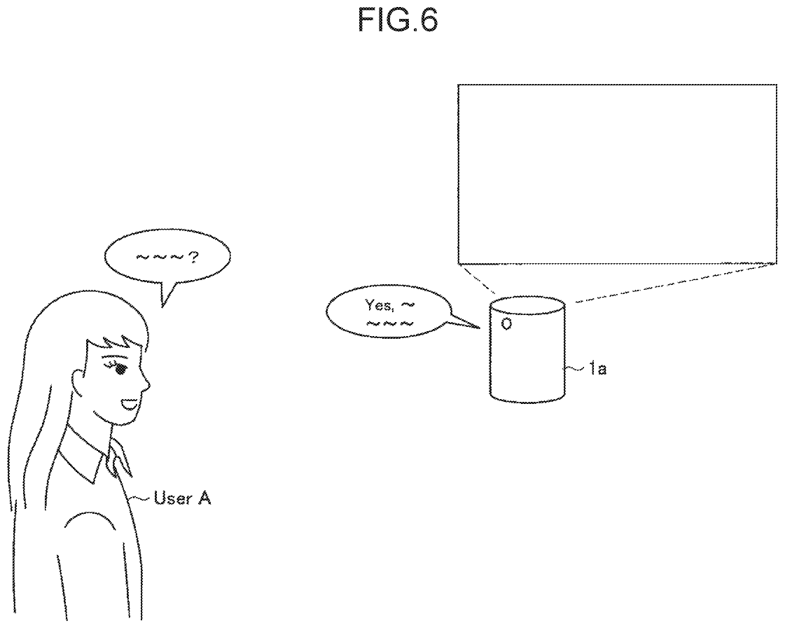

Next, an example of the functions of the information processing system according to the present embodiment will be described with reference to FIGS. 5 to 10.

The information processing system according to the first embodiment includes an information processing terminal 1a that collects product purchase request information from a first user (purchase requester), an information processing terminal 1b that appropriately presents product purchase request information to a second user (proxy purchaser), and an information processing server 2 that generates response information to each user. In the present embodiment, for example, it is assumed that the first user and the second user are family and an agent function provided by the system is shared by the family.

The information processing server 2 (virtual agent) can perform a conversation with each user via the information processing terminal 1a and the information processing terminal 1b. Although the form of the information processing terminal 1 is not particularly limited, for example, the information processing terminal 1a (such as a stationary dedicated device, see FIG. 6) disposed at home or the information processing terminal 1b worn by the second user (glasses-type HMD and the like) is assumed.

<3-1. Configuration>

The basic configuration of the information processing server 2 is as described with reference to FIG. 4, but in this embodiment, particularly in the response information generation unit 202 of the control unit 20, the collection of the product purchase request information or the response information for request are appropriately generated. A configuration of a response information generation unit 202-1 according to the present embodiment that generates the response information with the user related to such a request will be described with reference to FIG. 5.

FIG. 5 is a block diagram illustrating a configuration example of the response information generation unit 202-1 of the information processing server 2 according to the present embodiment. As illustrated in FIG. 5, the response information generation unit 202-1 functions as a request information collection response generation unit 300, a request contents determination unit 301, a priority calculation unit 302, a stepwise notification determination unit 303, an abstraction level determination unit 304, and a request response generation unit 305.

(Determination Function of Request Contents)

The response information generation unit 202-1 collects and determines the request contents by the request information collection response generation unit 300 and the request contents determination unit 301.

Specifically, the request information collection response generation unit 300 appropriately generates response information (question sentence) for collecting request information on a user's product purchase, and presents the generated response information to a user through the information processing terminal 1. Specific examples of the response information (question sentence) for collecting the request information will be described later, but for example, specific information related to purchase such as an item, a quantity, a price, and how to obtain (where to purchase or ask someone) is acquired through user interaction.

The request contents determination unit 301 determines the request content (in this case, the shopping content) as one from the conversation with the user. In this embodiment, the user asks a question until the request contents determination unit 301 determines that the request content is one, and when the necessary information is available, the request contents determination unit 301 determines whether or not the request content is correct after obtaining approval from the user.

(Request Function)

In addition, the response information generation unit 202-1 performs a purchase request response to a user through the priority calculation unit 302, the stepwise notification determination unit 303, the abstraction level determination unit 304, and the request response generation unit 305. When requesting a purchase to the user, it is preferable to present the purchase request information step by step from an item having high priority and abstraction level in a natural conversation flow with the user. As a result, for example, it is possible to avoid confusion of the user or excessive presentation of the information on the request to the user even when the request is refused by presenting detailed information at a time from the beginning.

Specifically, the priority calculation unit 302 calculates priorities of each item of the determined request contents. The priority calculation algorithm is not particularly limited, but for example, an item that is estimated to have a large influence when a proxy purchaser determines whether or not to perform a proxy purchase may be calculated high. For example, priority of information such as what to purchase, how much trouble is required for purchase, and whether it is an immediately necessary item is calculated high. The priority calculation unit 302 may calculate priority in consideration of the current state of the proxy purchaser. For example, when the proxy purchaser moves by bicycle or on foot, priority of information on carrying such as the number, size, and weight of purchased items is calculated high. Further, when a travel time to a purchase location based on a current location of a proxy purchaser and a transportation means exceeds a predetermined value, the priority of information on the purchase location is calculated high. Further, the priority of the amount of purchased item may be calculated according to the amount possessed by the proxy purchaser.

As the items of the request contents, for example, the following items can be considered as an example. The items listed below are merely examples, and the present embodiment is not limited thereto, and it is not always necessary to acquire the information on all the items below when collecting the request information from the purchase requester described above. The requested items may include items other than the items listed below.
Purchase request product-item, brand (sales/manufacturer), product name, product number, product image, size, weight, color, and the like.
Purchase reason (purpose)
Quantity
Budget
Purchase location-store name, address (map), store image, inventory status, price, discount information, and the like.
Desired time of purchase (during today, until 0 o'clock, until tomorrow, and the like)
Delivery address (family, friend, and the like)
Delivery method (when returning home and the like)
Payment method (wallet shared by family and the like)

The stepwise notification determination unit 303 determines whether to perform stepwise notification of the request information according to the environment of the user (proxy purchaser), and judges a stepwise notification method when the stepwise notification is performed. The user's environment is information on the user recognized by the recognition unit 201, and includes, for example, a user's situation (where and what is being done (or timing)), a usage status of an output device (information processing terminal 1), output characteristics, and the like. As the information processing terminal 1, various devices having different output characteristics such as a device capable of presentation with auditory information, a device capable of presentation with visual information, a device capable of presentation with auditory information and visual information, a device capable of presentation of a virtual object (AR display) as visual information are assumed. As the stepwise notification method, for example, stepwise output notification using visual information and auditory information, stepwise output notification using only auditory information, and stepwise output notification using only visual information, and the like are assumed.

For example, the stepwise notification determination unit 303 judges that the stepwise notification is possible when the user is running in the state in which he/she wears the glasses-type HMD (an example of the information processing terminal 1), and determines a method for stepwise notifying request information by voice and an image. In addition, even when the user is driving in the state in which he/she wears the glasses-type HMD (an example of the information processing terminal 1), it is determined that the stepwise notification is possible, and it is determined by a method for stepwise notifying request information with voice notification while driving and with an image when stopped. In addition, when the user is operating the smartphone terminal, it is assumed that the request information is presented as an image, but in this case, since a user more easily understand displaying the specific information on the request at a time than the stepwise notification, it may be determined that the stepwise notification is not performed.

The abstraction level determination unit 304 determines an abstraction level of the notification information at each step determined by the stepwise notification determination unit 303 according to the output unit. For example, the abstraction level determination unit 304 makes the abstraction level higher in the step of presentation with audio than in the step of presentation with an image. When detailed information is presented by voice, since the user is likely to be confused and difficult to remember contents, it is preferable to present information having a high abstraction level by voice presentation. On the other hand, in the case of image presentation, it is preferable to present information having a low abstraction level (high concreteness) because information on purchase can be easily communicated with text, diagrams, photographs, and the like.

The request response generation unit 305 generates response information (response (utterance) sentence, image, and the like) for notifying a user of abstract level request information corresponding to the abstraction level determined by the abstraction level determination unit 304. The items of the request information to be notified may be determined based on a predetermined order set in advance and may be determined randomly, and may be determined based on the priority calculated by the priority calculation unit 302, utterance contents (a question about request from the user, a flow of dialogue with the user) of the user, or the like.

For example, when generating based on the priority, the request response generation unit 305 first generates response information that inquires whether or not a proxy purchase is possible together with information on an item (for example, “purchase location”) having the highest priority among the items of the request information. At this time, the request response generation unit 305 presents information on an item having a higher priority at a level corresponding to the abstraction level determined by the abstraction level determination unit 304. For example, it can be said that when the request information item is “purchase location”, “purchase location name (store name)” has a high abstraction level, and “address (map)” and “store image” have a low abstraction level (high concreteness). For example, it can be said that when the item of the request information is “purchase request product”, the “item” has a high abstraction level, and “product name” and “brand” have the next highest abstraction level, “product number” and “product image” has a low abstraction level. Note that there may be a plurality of items of request information to be notified, and for example, in the case of voice presentation, response information for inquiring whether a proxy purchase is possible may be generated together with the purchase location information and the product information with a high abstraction level.

Further, the request response generation unit 305 basically may determine an item of request information to be notified based on a predetermined order set in advance or the calculated priority, and when there is a question from a user, may generate the response information primarily (with interrupt) including information on the questioned item.

In addition, the request response generation unit 305 may be used to estimate the knowledge of the purchase request item possessed by a user (proxy purchaser) from a purchase history of a user or family, and the like and recall the purchase request item when notifying the request information.

Further, the request response generation unit 305 according to the present embodiment is not limited to the generation of the response information for the stepwise notification of the request information, and may generate the response information for the request information notification as appropriate according to the user environment. For example, when the information processing terminal 1 used by the user has characteristics in which the stepwise notification is not preferable, such as a smartphone or a tablet terminal, the request response generation unit 305 may generate screen data which presents the specific request information as the response information at a time.

The response information generation unit 202-1 according to the present embodiment has been specifically described above. Subsequently, an operation process of this embodiment will be described.

<3-2. Operation Process>

(3-2-1. Process of Collecting Request Information)

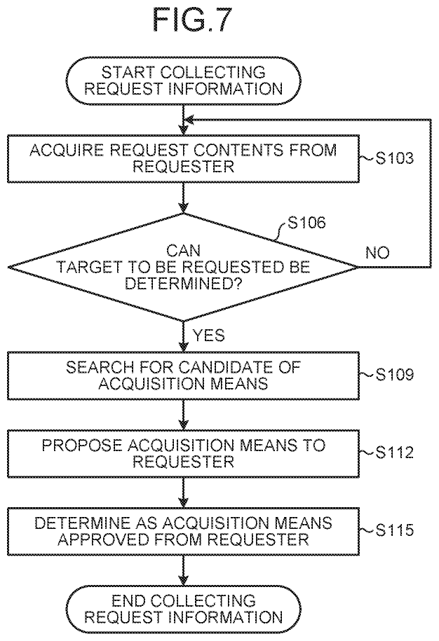

First, a collection process of request information from a purchase requester will be described with reference to FIGS. 6 and 7.

The request information from the purchase requester can be collected by voice dialogue between the user and the agent via the information processing terminal 1, for example. FIG. 6 is a diagram for explaining an example of the information processing terminal according to the present embodiment. As illustrated in FIG. 6, for example, the information processing terminal 1a may be realized by a stationary dedicated device, and the request information may be collected by performing a voice dialogue with the user A. At this time, analysis of utterance contents of user A speech or generation of an agent's voice response can be performed by the information processing server 2 connected to the information processing terminal 1a via the network 3, for example.

The information processing terminal 1a can present information by projecting an image on a wall surface by a voice response or, if necessary, a projector (for example, a small single focus projector) provided in the information processing terminal 1a. Here, as an example, a stationary dedicated device is illustrated, but the present embodiment is not limited thereto, and for example, the information processing terminal 1a may be a smartphone. In this case, the agent's voice response is output from the speaker of the smartphone, the user A is interacted, and the request information is collected.

FIG. 7 is a flowchart illustrating an operation process for collecting request information according to this embodiment. As illustrated in FIG. 7, first, the information processing server 2 uses the request information collection response generation unit 300 to acquire the request contents while interacting with the user A (requester) via the information processing terminal 1a (step S103).

Next, the information processing server 2 repeats the dialog with the client until the request contents determination unit 301 can determine the request target (step S106). As the request information to be collected, for example, information such as an item, a brand, a product name, and a product number of the purchased product, at least the product that can be identified, and information such as a quantity, a budget, and a desired purchase time are assumed.

Next, when a target has been determined (step S106/Yes), the request contents determination unit 301 searches for candidates of an acquisition means (step S109). Examples of the acquisition means include purchase on the Internet, purchase at an actual store, purchase request at an actual store, and the like.

Next, the request contents determination unit 301 proposes an acquisition means to the requester (step S112), and determines the acquisition means obtained from the requester (step S115).

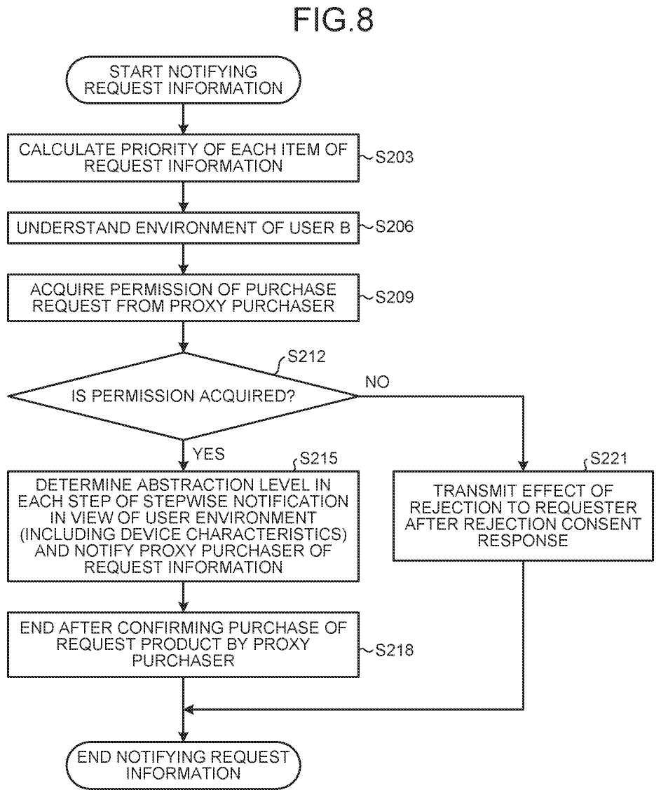

The information processing server 2 performs a product acquisition process determined based on the collected request information by an acquisition means approved by the client. In the case of Internet purchase, a predetermined mail order site or the like is displayed on the wall surface by the information processing terminal 1a, and the purchase processing is performed according to an instruction from the user A (or purchase processing is automatically performed). Further, when the user A himself/herself purchases at the actual store, the information processing server 2 displays a map up to an actual store on the wall surface by the information processing terminal 1a, or performs navigation or the like when the user A starts moving. Alternatively, when the purchase request at the actual store is approved, the information processing server 2 presents the purchase request and the request information to the proxy purchaser who is a request partner. The process of presenting the request information to the proxy purchaser will be described later with reference to FIG. 8.

The example of the request information collection process according to the present embodiment has been described above. Note that the operation process illustrated in FIG. 7 is an example, and the present disclosure is not limited to the example illustrated in FIG. 7. For example, the present disclosure is not limited to the order of the steps illustrated in FIG. 7. At least one of the steps may be processed in parallel, or may be processed in the reverse order. For example, after the determination of the acquiring method illustrated in step S115, the request contents acquisition process illustrated in step S103 may be performed to determine the target.

Further, all the processes illustrated in FIG. 7 need not be executed. For example, the acquisition method may be automatically determined by skipping the process of obtaining approval illustrated in step S115.

Further, all the processes illustrated in FIG. 7 do not necessarily have to be performed by a single device. For example, the processing from step S103 to step S106 may be performed by the information processing terminal 1a, and the processing from step S109 to step S115 may be performed by the information processing server 2.

Also, the processes illustrated in FIG. 7 do not necessarily have to be performed continuously in time. For example, after the processes illustrated in steps S103 to S109 are performed, the process illustrated in steps S112 to S115 may be performed at a predetermined timing (for example, when there is a request from the user, when the user is not busy, or when multiple purchase requests are accumulated).

Here, an example of a dialogue (via the information processing terminal 1a) with the user A (purchase requester) of the agent who collects the request information is illustrated below. The following dialogue example is in a situation where, for example, user A is consulting with an agent about the purchase of a present to be taken to a farewell party that participates today.

### Dialogue Example

Agent: “How about this dish?” (product presentation; information processing terminal 1a projects an image of a dish of a present candidate on a wall with a projector)

User A (wife): “Good, where can I buy it?”

Agent: “One is sold at the World Kitchen AA store near User A's office or at a store called CC miscellaneous goods near B Park.” (Presentation of purchase location information)

User A (wife): “Ah, CC miscellaneous goods is selling it?”

Agent: “Yes, this store has started to deal recently.”

User A (wife): “CC miscellaneous goods is not too far, but can we meet for the party time”

Agent: “User A, right now, your husband should be walking in the vicinity of Park B. Why don't you ask him to buy?”

(Search for an acquisition means and propose proxy purchase)

User A (wife): “Okay, good idea. Can I ask you?”

Agent: “Yes, I can. How many do you need?” (collection of request information; product information is already collected because it was recommended by the agent)

User A (wife): “Can I ask for two. You saved me.”

Agent: “Yes” (collection of request information is finished)

Here, the information processing server 2 proposes the proxy purchase by the user B as a candidate for the acquisition means. At this time, the information processing server 2 may consider the state of the proxy purchaser and propose the proxy purchase when the possibility of the proxy purchase is high. Here, “he state of the proxy purchaser” means, for example, the current location, the possessed amount (or a holding state of an alternative means such as a credit card), the means of carrying the purchased product assumed from the current transportation means (walking, bicycle, car), availability of time for a proxy purchase (schedule, dialogue with proxy purchaser, obtainable by context analysis by the recognition unit 201), and the like.

In the present embodiment, under the assumption that the agent is shared by family, for example, the user B who is the husband of the user A goes out wearing the information processing terminal 1b (glasses-type HMD) every day. For this reason, the information processing server 2 can recognize the state of the user B in real time. Therefore, for example, the information processing server 2 refers to the current state of the user B when there is the purchase request from the user A, and when the user B is running near the purchase location and can take the purchased item home, the proxy purchase to user B is proposed because the possibility of the proxy purchase is high. On the other hand, for example, when the user B is away from the purchase location, or if the user B is walking or riding a bicycle, the purchased item is heavy and difficult to take home, the possibility of the proxy purchase is low, and therefore the proposal of the proxy purchase to the user B is not performed.

In the above example of dialogue, the information processing server 2 accurately recognizes the position information of the user B who is the husband of the user A by the information processing terminal 1b (glasses-type HMD) worn by the user B, but in order to protect the privacy of a user, it is expressed as “the user B is probably walking near Park B”.

(3-2-2. Process of Notifying Request Information)

Next, the notification process of the request information to the proxy purchaser will be described with reference to FIG. 8. FIG. 8 is a flowchart illustrating an operation process for request information notification according to this embodiment.

As illustrated in FIG. 8, first, the priority calculation unit 302 of the information processing server 2 calculates priorities of each item of the request information collected from the user A (requester) according to the flow illustrated in FIG. 7 (step S203).

Next, the information processing server 2 understands the real-time environment of the user B (proxy purchaser) (step S206). Specifically, the information processing server 2 uses the recognition unit 201 (FIG. 4) to recognize the environment of the user B based on voice, an image, and various sensor information transmitted from the information processing terminal 1b worn by the user B (proxy purchaser).

Next, the information processing server 2 acquires a purchase request permission from the proxy purchaser (step S209). For example, the information processing server 2 interacts with the proxy purchaser via the information processing terminal 1b to check whether the proxy purchase is possible. At this time, the information processing server 2 may refer to the outline of the contents of the proxy purchase. For example, it is assumed that who is asking, the reason why an item is need, and what is needed to buy (information having a high abstraction level that cannot identify a product) like “Your wife asks you to purchase”, “Your wife wants you to buy a dish”, “Your wife wants you to buy a present for today's party.”.

Next, when permission can be obtained from the proxy purchaser (step S212/Yes), the information processing server 2 uses the stepwise notification determination unit 303, the abstraction level determination unit 304, and the request response generation unit 305 to determine the abstraction level in each step of the stepwise notification in view of the user environment (including device characteristics) and notify the proxy purchaser of the request information stepwise (step S215). Specifically, the information processing server 2 determines whether or not the stepwise notification determination unit 303 can perform the stepwise notification according to the user's environment. When performing the stepwise notification, the information processing server 2 determines the abstraction level of information to be notified according to the characteristics of the device, that is, an output means (sound, image display, and the like) as described above. For example, the abstraction level is high when presenting by voice, and the abstraction level is low when presenting by image display. Further, the request information to be notified may be determined according to the calculated priority or the dialogue with the user.

Then, after confirming the purchase of the request product by the proxy purchaser, the information processing server 2 ends the request information notification process (step S218). For example, it is possible to recognize that the proxy purchaser has purchased the request product from an image (a captured image corresponding to the field of view of the proxy purchaser) transmitted from the information processing terminal 1b.

On the other hand, if permission cannot be acquired (step S212/No), the information processing server 2 transmits a rejection consent response to the proxy purchaser (user B) and notifies the requester (user A) of the rejection.

The example of the operation process according to the present embodiment has been described above. Note that the operation process illustrated in FIG. 8 is an example, and the present disclosure is not limited to the example illustrated in FIG. 8. For example, the present disclosure is not limited to the order of the steps illustrated in FIG. 8. At least one of the steps may be processed in parallel, or may be processed in the reverse order. For example, the processes in steps S209 to S212 and the processes in step S215 may be performed in parallel or in the reverse order.

Also, all the processes illustrated in FIG. 8 need not be executed. For example, the priority calculation process illustrated in step S203 may be skipped.

Further, all processes illustrated in FIG. 8 do not necessarily have to be performed by a single device. For example, the processes may be performed by a plurality of apparatuses such as the information processing server 2 performing the processes of step S203 to step S212, the information processing terminal 1 performing the process of step S215, and the information processing server 2 performing the process of steps S218 and S221.

Further, the processes illustrated in FIG. 8 do not necessarily have to be sequentially performed in time. For example, the processes illustrated in steps S203 to S206 are periodically performed, and then the processes illustrated in steps S209 to S218 are performed at a predetermined timing (for example, when the request from the user is received, the user is in a predetermined state, or the like).

Here, an example of the dialogue (via the information processing terminal 1b) with the user B (proxy purchaser) when the request information is notified by the agent is illustrated below. In the following dialogue example, for example, a situation in which the user B wearing the information processing terminal 1b realized by the glasses-type HMD talks to an agent while running in a park (agent's voice is output from the speaker of the information processing terminal 1b) is assumed.

### Dialogue Example

Agent: “User B, are you okay now?”

User B (husband): “What happened?”

Agent: “Your wife wants you to buy a present for today's party.” (By voice presentation, the information processing server 2 first transmits the outline of the requested information (information having high abstraction level).

User B (husband): “Ah, the party in question, so what should I buy?”

Agent: “It's a dish sold at a store called CC miscellaneous goods. Your wife has bought it before.” (Information processing server 2 then notifies information having a relatively high abstraction level such as a name of a purchase location and item. In addition, the information processing server 2 may refer to the purchase history of the family and make a response reminiscent of knowledge of a purchase request item that the user B is estimated to have)

User B (husband): “Okay. Put the dish here.”

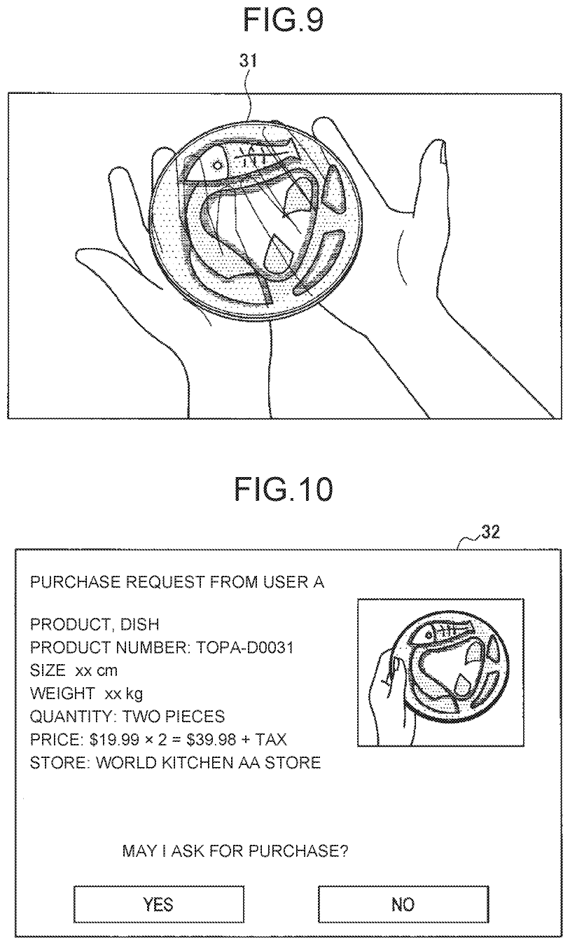

Agent: (As illustrated in FIG. 9, the information processing terminal 1b performs superposition display of the AR image 31 of the dish that is the purchase request product on both hands of the user B, and as a result, can present concrete (low abstraction level) information such as an appearance and size of the request product.

User B (husband): “Okay, so where is the dish sold?”

Agent: “CC miscellaneous goods is near here, may I ask for the purchase?” (Information processing server 2 responds that a purchase location is near and whether or not a proxy purchase is possible in response to the user's question.)

User B (husband): “Of course.”

Agent: “Thank you” (permission for a proxy purchase is acquired)

User B (husband): “Can you navigate to the site?”

Agent: “Okay, please turn left ahead” (Information processing server 2 calculates a route to a destination and continues navigation by voice below)

Next, an example of dialogue after arrival at the destination is illustrated.

### Example of Dialogue after Arrival at Store

User B (husband): “Well, what was it. Do you know what dish it is?”

Agent: “Would you like me to show an image again?”

User B (husband): “Yes, please”

Agent: “Here you are” (in response to a request from the agent, the information processing terminal 1b displays the AR image 31 again as illustrated in FIG. 9).

User B (husband): “Okay, I'll find it.”

User B (husband): “Oh, there it is, maybe it is the dish, right?”

Agent: “Yes, it is.” (information processing server 2 analyzes the dish that user B has in his hand by image recognition and recognizes whether it matches the purchase request item)

User B (husband): “How many pieces should I buy?”

Agent: “She says two pieces.” (in response to a question from User B, answer a quantity)

User B (husband): “Okay. Let's buy.”

Then, after confirming the purchase of the user B, the information processing server 2 ends the request information notification process.

### Example of Dialogue while Riding

Next, an example of dialogue regarding request information notification when a proxy purchaser is driving a car is illustrated below. While driving, the presentation of the request information that relies on visual information is not preferable for safety, and thus only notification with auditory information is provided. For safety reasons, it is preferable to avoid talking for a long time. The auditory information may be output from a car speaker or a speaker of a device worn by the user B.

Agent: “User B, are you okay now?”

User B (husband): “What happened?”

Agent: “Your wife wants you to buy a dish. You can buy the dish at a store about 2 miles from here.” (Information processing server 2 is preferentially notifying information on a purchase location because there is a distance to the purchase location. In addition, as to the contents of the request, information having a high abstraction level is presented regarding a product and a purchase location such as “dish” and “store at about 2 miles away from here”.)

User B (husband): “Of course.”

Agent: “Thank you.”

User B (husband): “Can you navigate to the site?”

Agent: “I understand, please turn right at the next traffic light.”

(Hereinafter, continue navigation by voice)

Agent: “It'll be arriving soon. It is a store called CC miscellaneous goods on the right. There is a vacancy in a parking lot, please park there.” (Because the destination is near, detailed information on the purchase location such as “CC miscellaneous goods” is presented.)

The dialogue in the notification of the request information after the user B gets off the car and enters the store after arrival at the destination is the same as the above-described example. In this way, it is possible to notify the user B who is driving by voice, and also notify by image when getting off a car, and present the request information stepwise.

(In Case of Smartphone)

When a proxy purchaser holds a smartphone (an example of the information processing terminal 1) and operates another application, as described above, the information processing server 2 determines that it is more preferable to notify specific information at a time with visual information than the stepwise notification. Even in such a case, the information processing server 2 first displays a purchase request notification message such as “There is a request for shopping from your wife” on the smartphone, and permission for a proxy purchase from the user B is acquired, and then detailed information may be presented.

For example, when the user B taps the purchase request notification display, the information processing server 2 presents the detailed information of the request information as illustrated in FIG. 10 on the display unit of the smartphone. FIG. 10 is a diagram illustrating an example in which the request information according to the present embodiment is presented on a smartphone screen. As illustrated in FIG. 10, the request information display screen 32 includes who requests it, an image of the purchase request product, product information (brand, serial number), a quantity, a price, a name of the purchase store, and the like. As a result, the user B can consider whether to permit the proxy purchase.

In addition, an option (“YES”, “NO”) of proxy purchase permission and inhibition is displayed on the request information display screen 32, and the user B can select permission and inhibition after confirming the contents.

<3-3. Effect>

As described above, in this embodiment, it is possible to request family in an appropriate situation (for example, family who is out and near a purchase location) through an agent shared by family and the like (agent function provided by the information processing system according to this embodiment), and provide a more comfortable living environment. Further, since the system side understands the situations of each user and appropriately determines the possibility of the proxy purchase, a user can reduce the trouble to check the status of the family who is out. In addition, it is possible to directly receive the proxy purchased product directly at home by asking the family.

In addition, the information processing system according to the present embodiment presents abstract information stepwise using visual information and auditory information at the time of request for proxy purchase, thereby making it possible to present the proxy purchase or the request information without confusing a proxy buyer.

### 4. Second Embodiment

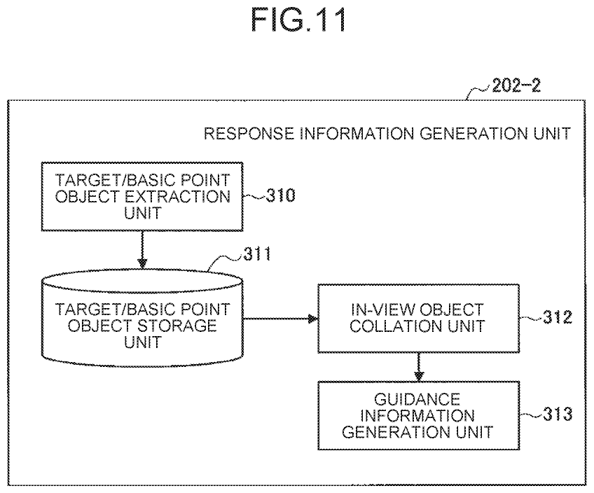

Next, another example of a function of an information processing system according to the present embodiment will be described with reference to FIGS. 11 to 16.

As described above, the technologies disclosed in Patent Literature 1 and Patent Literature 2 described above are effective when an object that the user is likely to be interested in enters the user's line-of-sight direction, and it is difficult for a system side to notify the user of an object what does not enter the user's line-of-sight direction.

As a result, the user may overlook the object which the user is likely to interest in.

For example, in the situation assumed in the first embodiment, after a user B arrives at a store, a guidance according to this embodiment is effective even when a target object cannot be found while the request product is searching in the store.

In the present embodiment, in the situation assumed in the first embodiment, when a user B arrives at a store and searches for an object, if there is an object that the user B is likely to be interested in by chance, it is possible to notify the user B and prevent overlooking.

Of course, the situation is not limited to the situation assumed in the first embodiment, and in this embodiment, when a predetermined object that a user has not noticed is found, it is possible to notify the user B and prevent overlooking.

A human visual field has a horizontal spread of about 180 to 210° horizontally, but sensitivity of a retina is high in a central part (fovea; part having the highest resolution and the best visual acuity), and the central part is narrow as about 2°. For this reason, the user does not always view all objects (real objects) recognized from an image corresponding to a user's field of view (image captured by an information processing terminal 1b worn by the user), and there are many objects that can be missed even when objects is within the field of view.

Therefore, in this embodiment, it is possible to prevent overlooking by guiding the user to a target object outside the field of view using a basic point object that easily attracts user's visual attention.

An information processing system according to this embodiment includes an information processing terminal 1b that senses a user's situation, and an information processing server 2 that notifies the user of a position of a predetermined target object extracted from an image corresponding to a user's field of view by the information processing terminal 1b. Notification to the user can be performed by an artificial voice as an example of an agent function provided by the present system.

The information processing terminal 1b is provided with a camera (outward camera 110) that captures an image corresponding to a user's field of view, and is assumed to be realized by, for example, the glasses-type HMD as described with reference to FIG. 1.

<4-1. Configuration>

A basic configuration of the information processing server 2 is as described with reference to FIG. 4, but in this embodiment, in particular, a response information generation unit 202 of a control unit 20 appropriately generates response information for guiding a user to a target object outside a field of view using a basic point object that is easy to draw the user's visual attention extracted from the image corresponding to the user's field of view. The configuration of the response information generation unit 202-2 according to the present embodiment that generates the response information for guidance to a target object outside the field of view will be described with reference to FIG. 11.

FIG. 11 is a block diagram illustrating a configuration example of the response information generation unit 202-2 of the information processing server 2 according to the present embodiment. As illustrated in FIG. 11, the response information generation unit 202-2 functions as a target/basic point object extraction unit 310, a target/basic point object storage unit 311, an in-view object collation unit 312, and a guidance information generation unit 313.

The target/basic point object extraction unit 310 extracts a target object and a basic point object from an image corresponding to the user's field of view. Here, the “image corresponding to the user's field of view” preferably has a horizontal angle of view of 180 to 210° corresponding to the human visual field as described above, but does not necessarily have this angle of view, and have an angle of view which may be a direction corresponding to the user's line-of-sight than a visual center (2° horizontal) or an effective visual field (about 30° horizontal) having excellent information receiving ability. For example, the angle of view may be about 60 to 90° in a horizontal direction corresponding to the user's line-of-sight. Further, in this specification, the “target object” is a predetermined object notified to the user among objects arranged in a real space, for example, an object estimated to be interested by the user. The object estimated to be interested by the user can be determined based on, for example, a user's hobby preference, a user's favorite list (bookmark), a search history, a shopping list, a belongings list, a behavior history, a user context, and the like. The information is stored in a user information DB 221 (see FIG. 4). Alternatively, the “target object” may be an object (for example, an advertisement product, a recommended product, a topic product, and the like) that is registered in advance and is to be notified to a user.

Further, in the present specification, the “basic point object” is assumed to be an object that is arranged around the target object in the real space and easily attracts person's visual attention (person is likely to notice), but more preferably, is an “object visually recognized by a user”.

For example, when a user's gazing point overlaps an object recognized from an image corresponding to the user's field of view (for example, continued for a time exceeding a predetermined threshold), the target/basic point object extraction unit 310 may specify the object as “object recognized by a user”. The user's gazing point can be recognized based on an image of user's eyes acquired by an inward camera 111 acquired from the information processing terminal 1, a position and posture of a user's head, or the like.

Note that a method of specifying an “object visually recognized by a user” is not limited to the method based on the user's gazing point, and for example, an object staying at an approximate center (that is, the center of the direction in which the user points the line-of-sight) of the image corresponding to the user's field of view for a predetermined time or more may be specified as the object visually recognized by the user.

Further, the basic point object does not necessarily have to be the object visually recognized by the user. For example, an object (conspicuous object) that satisfies a predetermined criterion that is estimated to be most prominent to a user, such as a conspicuous or large color (hue, luminance) in the image corresponding to the user's field of view, may be specified as a basic point object. Further, an object (for example, an object having the largest size) that is located around the target object and is estimated to be most prominent among the objects visually recognized by the user may be specified as the basic point object. The “color is conspicuous” means, for example, a highly saturated warm color (an attractive color that attracts human eyes) or a color that is conspicuous against a certain background color (color having high visibility such as ease of view or ease of confirmation when viewed) is assumed. In addition, the “large” is assumed to be larger than a predetermined size, larger than surrounding objects, or a large proportion (exceeding a predetermined proportion) of an area occupied in the image corresponding to the user's field of view. Further, the target/basic point object extraction unit 310 may extract the target object and the basic point object by a calculation process using a neural network or the like optimized by a predetermined machine learning process.

The basic point object that is likely to attract the person's visual attention (preferably, gazed by a user) is useful information that can be used to transmit a position of a target object that is easy to remain in a user's memory and that is not noticed by the user. In particular, when the target object is out of field of view, it is difficult to present the position of the target object by voice or AR display, but it is possible to notify “close to ∘∘”, “next to ∘∘” and to notify the location of the target object more easily by using the position of the basic point object that the user remembers.

The target/basic point object extraction by the target/basic point object extraction unit 310 may be performed using the above-described object recognition technology (general object recognition, specific object recognition, and the like). Alternatively, the target/basic point object extraction unit 310 may extract the target object and the basic point object based on the result of object recognition from the image corresponding to the user's field of view by the recognition unit 201. Alternatively, the target object and the basic point object may be extracted by the recognition unit 201.

Information on the extracted target object and basic point object is stored in the target/basic point object storage unit 311.

The target/basic point object storage unit 311 stores target object information that is information on the target object extracted by the target/basic point object extraction unit 310 and basic point object information that is information on the basic point object (for example, an object name, three-dimensional position information, an object shape, a size, a feature value, a color, an object image, names of features (people or animals, locations, and the like that a user can recognize on an object) included in the object image, an attribute, and the like for each target object and basic point object. In addition, information indicating the relationship between the target object and the basic point object, such as a positional relationship of top, bottom, left and right or a depth or a contrast relationship of luminance of the target object and the basic point object). It is possible to perform guidance to the target object using the basic point object later by storing the target object information and the basic point object information in this way. For example, when the target object or the basic point object is immediately out of the user's field of view, when the target object or the basic point object is not extracted in real time, or even when the target object is guided to the target object at an appropriate timing considering the user's situation, it is possible to perform the guidance to the target object using the basic point object. Note that there are no particular limitations on time and distance limitations of “after”, but it is preferable to perform guidance to the target object before a user moves away from the target object and the basic point object (a predetermined distance or more), for example.

The in-view object collation unit 312 collates a predetermined target object to be guided from the image corresponding to the user's field of view or collates the basic point object stored in the target/basic point object storage unit 311.

The guidance information generation unit 313 generates information for guidance to the predetermined target object according to the collation result by the in-view object collation unit 312. For example, when the predetermined target object to be guided cannot be collated from the image corresponding to the user's field of view (that is, when the target object is not in the user's field of view), the guidance information generation unit 313 uses the information on the basic point object located around the target object located near the user registered in the target/basic point object storage unit 311 to generate information (an example of response information) for guiding voice to the target object. In addition, when the basic point object used for the guidance is in the user's field of view, the guidance information generation unit 313 may generate information (an example of the response information) for specifically notifying the positional relationship between the basic point object and the target object by voice. The response information is synthesized by the voice synthesis unit 203 (see FIG. 4), transmitted to the information processing terminal 1b via the communication unit 21 by the output control unit 204, and output from the speaker 14 of the information processing terminal 1b (see FIG. 3). In addition, the guidance using the basic point object to the predetermined target object is not limited to the guidance using the positional relationship between the target object and the basic point object, and for example, the information for guiding voice to the predetermined target object may be generated using an object name, an object shape, a size, a feature amount, a color, names of features (people or animals, locations, and the like that a user can recognize on an object) included in an object image, an attribute, and the like, or the information indicating the relationship between the target object and the basic point object such as the contrast relationship of luminance between the target object and the basic point object. Further, information for guiding and displaying an image of the basic point object may be generated.

Further, the guidance information generation unit 313 generates information (an example of the response information) for displaying an AR image (AR marking) around the target object so that the target object is visually recognized when the predetermined target object to be guided is within the user's field of view. The generated AR image display information is transmitted to the information processing terminal 1b via the communication unit 21 by the output control unit 204, and displayed around the target object (real object) in the display unit 13 (see FIG. 3) of the information processing terminal 1b.

The response information generation unit 202-2 according to the present embodiment has been described above in detail. Subsequently, an operation process of this embodiment will be described.

<4-2. Operation Process>

(4-2-1. Process of Registering Target Object and Basic Point Object)

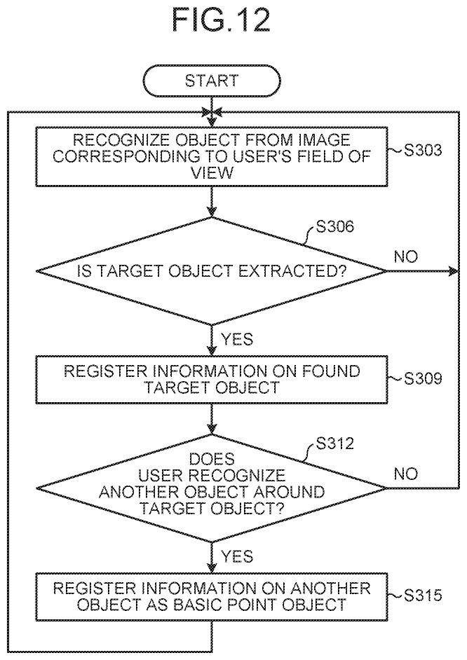

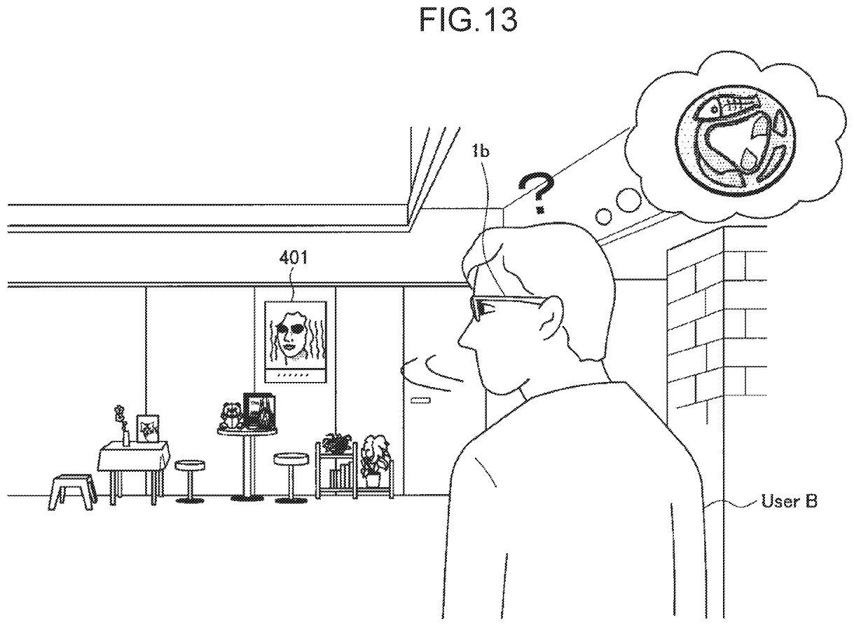

First, the registration process of the target object and the basic point object will be described with reference to FIG. 12. FIG. 12 is a flowchart illustrating a registration process of a target object and a basic point object according to the present embodiment.

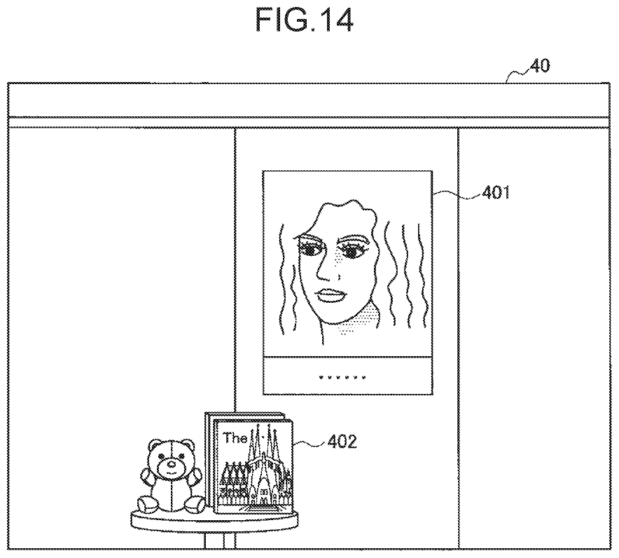

As illustrated in FIG. 12, first, the information processing server 2 recognizes an object from an image corresponding to the user's field of view (step S303). The image corresponding to the user's field of view is captured by the outward camera 110 of the information processing terminal 1 worn by the user and transmitted to the information processing server 2. Here, as an example, it is assumed that a user B is acting while wearing information processing terminal 1b. FIG. 13 is a diagram for explaining the situation of the user B according to the present embodiment.

As illustrated in FIG. 13, in the present embodiment, for example, it is assumed that the user B visits a store where he/she buys dishes and is searching for dishes. The user B pays attention to a poster 401 attached to the front for a moment, but because the dish is not found, the user B takes his/her eyes off and searches for another location. At this time, the information processing terminal 1b worn by the user B captures an image (video) corresponding to the field of view of the user B by the outward camera 110, and the information processing server 2 recognizes an object within the field of view based on the captured image.

Next, when the target object is extracted from the user's field-of-view image by the object recognition (step S306/Yes), the information processing server 2 registers information (for example, three-dimensional position information) on the discovered target object (step S309). The target object is a real object that a user is likely to be interested in based on, for example, a user's hobby or a behavior history. Specifically, for example, on the system side, when the user B understands information on the location where the next trip is scheduled to be visited (it can be understood from a user's schedule, contents of dialogue with the agent, a user's search history, and the like), it can be estimated that the user is interested in an object related to a travel destination. In this case, for example, when the object (guidebook with a photo of a sightseeing spot on a cover, and the like) related to the travel destination is recognized from the field of view of user B, it is judged that the target object is in the field of view (target object is extracted).

Next, when the user recognizes other objects around the target object (step S312/Yes), the information processing server 2 registers the recognized other objects as the basic point object, that is, the basic point object information (for example, three-dimensional position information, shape information, feature amount, and the like) (step S315). Here, FIG. 14 is a diagram illustrating an example of extracting a target object and a basic point object from an image corresponding to the user's field of view. First, the information processing server 2 extracts a target object 402 that a user is likely to be interested in from the captured image 40 illustrated in FIG. 14 by object recognition (for example, based on a feature amount or pattern recognition of a cover image of the target object 402) At this time, the information processing server 2 extracts an object (poster 401) existing around the target object 402 and recognized by the user (for example, the user's gazing point (range of a central vision) is overlapped for a certain period of time) as a basic point object.

The registration process of the target object and the basic point object described above can be performed continuously or intermittently.

Note that the operation process illustrated in FIG. 12 is an example, and the present disclosure is not limited to the example illustrated in FIG. 12. For example, the present disclosure is not limited to the order of the steps illustrated in FIG. 12. At least one of the steps may be processed in parallel, or may be processed in the reverse order.

For example, the registration process of the basic point object illustrated in steps S312 to S315 is not limited to being performed when the target object is found (in the case of “Yes” in step S306), but all the objects (or a prominent object among them) recognized (gazed) by the user may be registered as the basic point object. In this case, even when the target object is not in a field of view, if the three-dimensional position information of the target object can be acquired, it is possible to extract the registered basic point object located near the three-dimensional position information and use the extracted basic point object for guidance.

In addition, all the processes illustrated in FIG. 12 may not necessarily be executed. For example, the process of step S312 may be skipped. That is, not only the object visually recognized by the user, but also an object that attracts (stands out) person's attention around the target object may be registered as the basic point object. This is because when guiding using the basic point object, even if the user does not memorize the location of the basic point object, if the object is conspicuous, it can be expected that the user will immediately notice the basic point object when looking around.

In addition, all the processes illustrated in FIG. 12 may not necessarily be executed by a single apparatus. For example, the processes may be performed by the plurality of apparatuses like the information processing terminal 1 performing the processes from step S303 to step S306, the information processing server 2 performing the processes from step S309 to step S315, and the like. Further, all the processes illustrated in FIG. 12 may be performed by the information processing terminal 1.

In addition, each process illustrated in FIG. 12 may not necessarily be performed sequentially in time. For example, the processes illustrated in steps S303 to S309 are performed immediately after a new captured image is acquired or when a certain amount of captured images are accumulated, and then the processes illustrated in steps S312 to S315 may be performed in a predetermined timing (a set cycle or the like).

(4-2-2. Process of Guidance to Target Object)

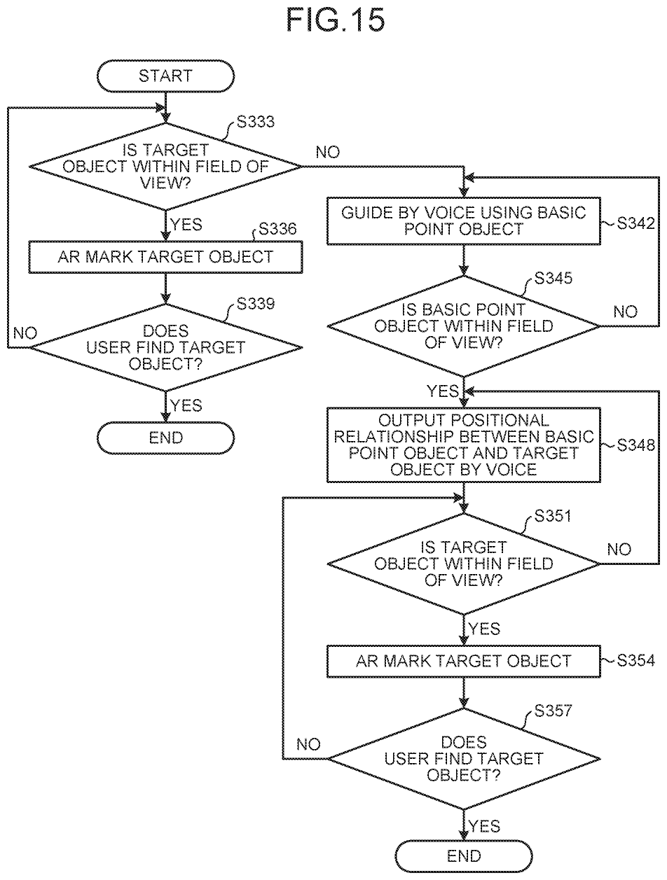

Next, the guidance process to the target object will be described with reference to FIG. 15. FIG. 15 is a flowchart illustrating the guidance process to the target object according to the present embodiment. The guidance process illustrated in FIG. 15 may be started in response to a predetermined guidance trigger such as an appropriate timing according to the user's situation, for example.

As illustrated in FIG. 15, first, the information processing server 2 determines whether or not the target object is in the field of view based on an image corresponding to a current user's field of view (step S333).

Next, when the target object is within the field of view (step S333/Yes), the information processing server 2 AR marks the target object (step S336).

Next, it is determined whether or not the user has found the target object (step S339). The information processing server 2 can determine whether or not the user has found the target object from the user's line-of-sight (gaze position), the user's utterance, action, and the like.

When a user finds the target object (step S339/Yes), the information processing server 2 ends the guidance process.

On the other hand, when the target object is not within the field of view (step S333/Yes), the information processing server 2 guides the user by voice using the registered basic point object (step S342). Specifically, for example, the information processing server 2 generates voice information notifying that there is the target object near the registered basic point object existing around the target object, and controls the generated voice information to be output from the information processing terminal 1b. Since the basic point object is an object at least gazed by the user as described above, if the name and characteristics of the basic point object are presented, the user can expect to remember a certain position. In addition, since it is assumed that the basic point object gazed by the user is conspicuous, even when the position cannot be remembered, it can be expected that attention is easily drawn when looking around.

Next, the information processing server 2 determines whether or not the basic point object is included in the user's field of view (step S345).

Next, when the basic point object is within the user's field of view (step S345/Yes), the information processing server 2 controls the positional relationship between the basic point object and the target object to be output from the information processing terminal 1b by, in particular, voice (step S348). This makes it easier for the user to search for the target object.

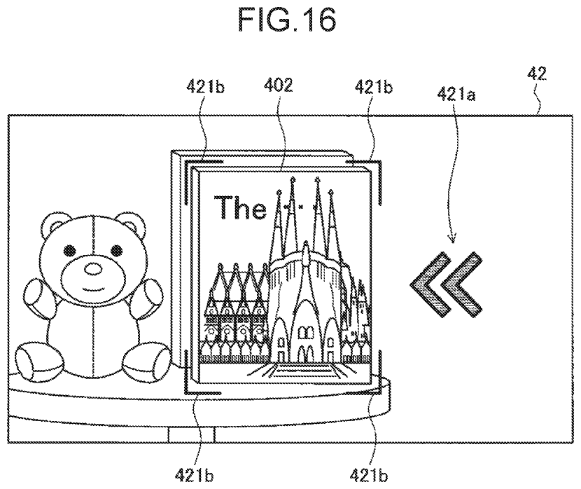

Next, when the target object is within the user's field of view (step S351/Yes), the information processing server 2 AR marks the target object (step S354). By doing so, more explicit guidance to the target object can be performed. Here, FIG. 16 illustrates an example of AR marking on the target object according to the present embodiment. As illustrated in FIG. 16, an AR image 421a of an arrow pointing to the target object 402, an AR image 421b surrounding the target object 402, or the like are displayed around the target object 402 extracted within the user's field of view 42, so that the target object 402 is noticed more reliably.

When a user finds the target object (step S357/Yes), the information processing server 2 ends the guidance process.

The guidance process according to the present embodiment has been described above in detail. Note that the operation process illustrated in FIG. 15 is an example, and the present disclosure is not limited to the example illustrated in FIG. 15. For example, the present disclosure is not limited to the order of the steps illustrated in FIG. 15. At least one of the steps may be processed in parallel, or may be processed in the reverse order. In addition, all the processes illustrated in FIG. 15 may not necessarily be executed.

For example, the processes of step S354 and step S357 may be performed in the reverse order. Specifically, the AR marking of the target object may be performed when the user cannot find the target object even if the target object is within the user's field of view.

Further, the processes of steps S342 to S345 may be skipped. That is, the positional relationship between the basic point object and the target object may be specifically output regardless of whether or not the basic point object is in the field of view.

In addition, all the processes illustrated in FIG. 15 need not necessarily be executed by a single apparatus. For example, the processes may be performed by the plurality of apparatuses like the information processing terminal 1 performing the processes from step S333 to step S339, the information processing server 2 performing the processes from step S342 to step S357, and the like. Further, all the processes illustrated in FIG. 15 may be performed by the information processing terminal 1.

In addition, each process illustrated in FIG. 15 may not necessarily be performed sequentially in time. For example, the process illustrated in steps S333 to S339 may be immediately performed every time a new captured image is acquired, and the processes illustrated in steps S342 to S357 may be performed at a predetermined timing (appropriate timing according to the user situation, before being away from the target object by a predetermined distance, or the like).

### Dialogue Example

Hereinafter, an example of the guidance voice according to the present embodiment is illustrated. Here, as an example, the agent function provided by the information processing server 2 performs guidance while being dialogue with the user B. As a situation, it is assumed that the user B visiting the store finds the dish requested by the user A and goes to a cash register. The voice of the agent is output from the information processing terminal 1b worn by the user B.

Agent: “User B.” (the agent is talking at a timing when the user B's work is finished)

User B: “What's wrong?”

Agent: “Look, there is a [symbol] church book that you plan to visit in the next family trip.” (The book about the travel destination that is understood from the user B's schedule, the search history, and the like is specified as the target object that is estimated to be of interest to the user. The agent extracted the book from the user's field of view while the user B was looking for a dish and memorized the extracted book.)

User B: “Oh, where is it?”

Agent: “Under a female poster.” (When the agent extracted the book as the target object, the agent specified and memorized the female poster that was disposed around the target object and gazed by the user as the basic point object.)

User B: “That's true. It's the same as the photo I saw at home.” (The user B looks around and finds a female poster, approaches the female poster, and finds a book below the poster. A photo of [symbol] church previously presented by an agent as travel destination information is posted on the cover of the book.)

In the above dialogue example, the process of guiding the user to one target object using one basic point object was performed, but this embodiment is not limited to the above example, and the guidance to the target object using the plurality of basic point objects or the guidance process to the plurality of target objects using the basic point object can be executed. For example, the agent may execute guidance such as “there is a target object A between a basic point object A and a basic point object B”, guidance such as “there are target object B and target object C beside basic point object C”, and furthermore, a guidance process such as “there are target object D and target object E toward basic point object D and basic point object E”. In this case, the target/basic point object storage unit 311 stores a plurality of basic point object information or a plurality of target object information, and the control unit 20 performs the guidance process according to the process examples and the like that are described using the plurality of stored basic point object information and the plurality of stored target object information.

<4-3. Effect>

As described above, in this embodiment, by guiding the target object outside the field of view using the basic point object, it is possible to transmit the target object to the user more smoothly and easily and prevent the overlooking of the target object outside of the field of view.

### 5. Hardware Configuration

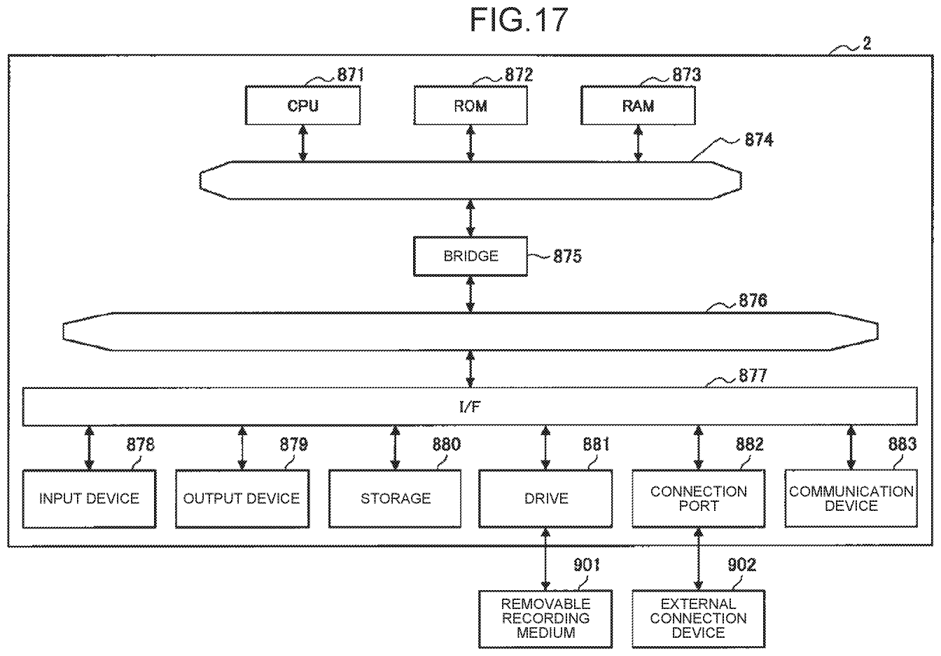

Next, a hardware configuration example common to the information processing terminal 1 and the information processing server 2 according to the embodiment of the present disclosure will be described. FIG. 17 is a block diagram illustrating a hardware configuration example of the information processing terminal 1 and the information processing server 2 according to the embodiment of the present disclosure. Referring to FIG. 17, the information processing terminal 1 and the information processing server 2 include, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. In addition, components other than the component illustrated here may be included.

(CPU 871)

A CPU 871 functions as, for example, an arithmetic processing device or a control device, and controls the overall operation of each component or a part thereof based on various programs recorded in the ROM 872, the RAM 873, the storage 880, or a removable recording medium 901.

Specifically, the operations of the recognition unit 120, the response information acquisition unit 121, and the output control unit 122 in the information processing terminal 1 are realized. Alternatively, the operations of the recognition unit 201, the response information generation unit 202 (202-1 and 202-2), the voice synthesis unit 203, and the output control unit 204 in the information processing server 2 are realized.

(ROM 872 and RAM 873)

The ROM 872 is a means for storing a program read by the CPU 871, data used for calculation, or the like. The RAM 873 temporarily or permanently stores, for example, a program read into the CPU 871 and various parameters varying as appropriate when the program is executed.

(Host Bus 874, Bridge 875, External Bus 876, Interface 877)

The CPU 871, the ROM 872, and the RAM 873 are connected to each other via, for example, the host bus 874 capable of high-speed data transmission. On the other hand, the host bus 874 is connected to the external bus 876 having a relatively low data transmission speed via the bridge 875, for example. In addition, the external bus 876 is connected to various components via the interface 877.

(Input Device 878)

As the input device 878, for example, a mouse, a keyboard, a touch panel, a button, a switch, a lever, and the like are used. Furthermore, as the input device 878, a remote controller (hereinafter referred to as a remote controller) capable of transmitting a control signal using infrared rays or other radio waves may be used. In addition, the input device 878 includes a voice input device such as a microphone.

(Output Device 879)

The output device 879 is a display device such as a cathode ray tube (CRT), an LCD, or an organic EL, an audio output device such as a speaker or a headphone, a device capable of notifying the user of the acquired information visually or audibly, such as a printer, a mobile phone or a facsimile. In addition, the output device 879 according to the present disclosure includes various vibration devices that can output a tactile stimulus.

(Storage 880)

The storage 880 is a device for storing various data. As the storage 880, for example, a magnetic storage device such as a hard disk drive (HDD), a semiconductor storage device, an optical storage device, or a magneto-optical storage device is used.

(Drive 881)

The drive 881 is a device that reads information recorded on the removable recording medium 901 such as the magnetic disk, the optical disk, the magneto-optical disk, or the semiconductor memory, or writes information in the removable recording medium 901.

(Removable Recording Medium 901)

The removable recording medium 901 is, for example, DVD media, Blu-ray (registered trademark) media, HD DVD media, various semiconductor storage media, and the like. Of course, the removable recording medium 901 may be, for example, an IC card on which a non-contact IC chip is mounted, an electronic device, or the like.

(Connection Port 882)

The connection port 882 is a port for connecting the external connection device 902 such as a universal serial bus (USB) port, an IEEE1394 port, a small computer system interface (SCSI), an RS-232C port, or an optical audio terminal.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, and is, for example, a communication card for wired or wireless LAN, Bluetooth (registered trademark) or WUSB (Wireless USB), a router for optical communication, a router for an asymmetric digital subscriber line (ADSL), various communication modems, or the like.

### 6. Summary

As described above, in the information processing system according to the embodiment of the present disclosure, it is possible to prevent the target object outside the field of view from being overlooked.

As described above, the preferred embodiments of the present disclosure have been described in detail with reference to the accompanying drawings, but the present disclosure is not limited to such examples. It will be apparent to those skilled in the art of the present disclosure that various changes or modifications can be conceived within the scope of the technical idea described in the claims, and it is naturally understood that these changes or modifications fall within the technical scope of the present disclosure.

For example, it is possible to create a computer program for executing the information processing terminal 1 or the information processing server 2 on hardware such as the CPU, the ROM, and the RAM incorporated in the information processing terminal 1 or the information processing server 2 described above. In addition, a computer-readable storage medium storing the computer program is also provided.

Further, the first embodiment and the second embodiment may be combined, or may be implemented independently.

In addition, the target object and the basic point object described above are not limited to the real objects in the real space, but may be virtual objects arranged in the real space or the virtual space (three-dimensional space).

In addition, the effects described in the present specification are merely illustrative or exemplary, and are not limited to those described in the present specification. That is, the technology according to the present disclosure can exhibit other effects apparent to those skilled in the art from the description of the present specification, in addition to or instead of the effects described above.

Note that the present technology can also be configured as follows.

(1)

An information processing apparatus, comprising: a control unit that

extracts a target object and a basic point object from an image corresponding to a user's field of view,

stores basic point object information on the basic point object in a storage unit,

determines whether the target object is included in an image corresponding to a current field of view when the user is guided to the target object, and

performs a process of presenting a position of the target object using the stored basic point object information when the target object is not included in an image corresponding to the current field of view.

(2)

The information processing apparatus according to (1), wherein the control unit performs control to present a position of the target object using the basic point object information by voice.

(3)

The information processing apparatus according to (2), in which the control unit presents a positional relationship between the basic point object and the target object by voice.

(4)

The information processing apparatus according to (2) or (3), wherein the control unit performs control to store three-dimensional position information of the extracted target object and basic point object in the storage unit.

(5)

The information processing apparatus according to any one of (2) to (4), wherein the control unit performs object recognition from an image corresponding to the user's field of view, and extracts, as the target object, an object estimated to be of interest to the user based on the registered user information.

(6)

The information processing apparatus according to any one of (2) to (4), wherein the control unit performs object recognition from an image corresponding to the user's field of view, compares the recognized object with a predetermined target object registered in advance, and extracts the target object.

(7)

The information processing apparatus according to any one of (2) to (6), wherein the control unit performs object recognition from the image corresponding to the user's field of view and specifies an object that satisfies a predetermined condition as a basic point object.

(8)

The information processing apparatus according to (7), wherein the control unit specifies an object that is located around the target object and visually recognized by the user as a basic point object.

(9)

The information processing apparatus according to (7) or (8), wherein the control unit identifies an object that is positioned around the target object and has at least a color or size satisfying a predetermined criterion in the image corresponding to the user's field of view as a basic point object.

(10)

The information processing apparatus according to any one of (2) to (9), wherein when a target object to be guided is in the user's field of view, the control unit performs control to clearly indicate a position of the target object by an AR image.

(11)

The information processing apparatus according to any one of (2) to (10), further comprising: a transmission unit that transmits information on guidance of the target object to an information processing terminal possessed by the user.

(12)

The information processing apparatus according to (11), wherein the information processing terminal is a head-mounted device worn by the user.

(13)

The information processing apparatus according to any one of (2) to (12), wherein the control unit performs control to start guidance to the target object at a timing according to a situation of the user.

(14)

An information processing method, comprising:

extracting, by a processor, a target object and a basic point object from an image corresponding to a user's field of view;

storing, by the processor, basic point object information on the basic point object in a storage unit;

judging, by the processor, whether the target object is included in an image corresponding to a current field of view when guiding the user to the target object; and

performing, by the processor, a process of presenting the position of the target object using the stored basic point object information when the target object is not included in the image corresponding to the current field of view.

(15)

A program allowing a computer to function as a control that

extracts a target object and a basic point object from an image corresponding to a user's field of view,

stores basic point object information on the basic point object in a storage unit,

judges whether the target object is included in an image corresponding to a current field of view when guiding the user to the target object, and

performs a process of presenting the position of the target object using the stored basic point object information when the target object is not included in the image corresponding to the current field of view.

In addition, the present technology can also be configured as follows.

(20)
An information processing apparatus including: a control unit that

determines a method for stepwise notifying predetermined information based on environment information of a user including characteristics of an information processing terminal used by a user, and

performs control to determine an abstraction level of notification information in each step according to an output means in the information processing terminal of the notification information.

(21)

The information processing apparatus described in (20), in which the control unit judges whether to perform the stepwise notification using either auditory information or visual information or both the auditory information and the visual information as the predetermined information based on the characteristics of the output means of the information processing terminal included in the environment information of the user.

(22)

The information processing apparatus described in (21), in which the control unit judges use whether the stepwise notification is performed in consideration of a status of the user included in the environment information of the user.

(23)

The information processing apparatus described in (21) or (22), in which the visual information includes a virtual object superimposed and displayed in a real space.

(24)

The information processing apparatus described in any one of (20) to (23), in which the control unit determines an abstraction level higher than a predetermined value in a case of a notification step by a voice output means.

(25)

The information processing apparatus described in any one of (20) to (24), in which the control unit determines an abstraction level lower than the predetermined value in a case of a notification step by a display means.

(26)

The information processing apparatus described in any one of (20) to (25), in which the control unit performs control to notify a high priority item among respective items of the predetermined information in each step.

(27)

The information processing apparatus described in any one of (20) to (26), in which the control unit generates response information including notification information of the determined resolution, and the performs control to output from the information processing terminal.

(28)

The information processing apparatus described in (27), in which the control unit performs control to synthesize an artificial voice of the response information and output the synthesized voice information from the information processing terminal.

(29)

The information processing apparatus described in (27) or (28), in which the notification information to be notified in each step is determined based on a questionnaire the priority of each item related to the predetermined information from the user based on a user's uttered voice collected by the information processing terminal.

(30)

The information processing apparatus described in any one of (20) to (29), in which the predetermined information is information on a request for proxy purchase to the user.

(31)

The information processing apparatus described in (30), in which the control unit

determines feasibility of the proxy purchase of the user based on the information on the request for the proxy purchase and the status of the user, and

performs the stepwise notification of the information on the request of the proxy purchase when there is the feasibility.

(32)

The information processing apparatus described in any one of (20) to (31), in which the information processing terminal is a glasses-type HMD attached to a user's head.

(33)

An information processing method including:

determining, by a processor, a method for stepwise notifying predetermined information based on environment information of a user including characteristics of an information processing terminal used by a user; and

performing, by the processor, control to determine an abstraction level of notification information in each step according to an output means in the information processing terminal of the notification information.

(34)

A program for allowing a computer to function as a control unit that:

determines a method for stepwise notifying predetermined information based on environment information of a user including characteristics of an information processing terminal used by a user; and

performs control to determine an abstraction level of notification information in each step according to an output means in the information processing terminal of the notification information.

### REFERENCE SIGNS LIST

1(1a, 1b) INFORMATION PROCESSING TERMINAL
2 INFORMATION PROCESSING SERVER
3 NETWORK
11 SENSOR UNIT
12 CONTROL UNIT
120 RECOGNITION UNIT
121 RESPONSE INFORMATION ACQUISITION UNIT
122 OUTPUT CONTROL UNIT
13 DISPLAY UNIT
14 SPEAKER
15 COMMUNICATION UNIT
16 OPERATION INPUT UNIT
17 STORAGE UNIT
20 CONTROL UNIT
201 RECOGNITION UNIT
202 RESPONSE INFORMATION GENERATION UNIT
202-1 RESPONSE INFORMATION GENERATION UNIT
202-2 RESPONSE INFORMATION GENERATION UNIT
203 VOICE SYNTHESIS UNIT
204 OUTPUT CONTROL UNIT
21 COMMUNICATION UNIT
22 STORAGE UNIT
221 USER INFORMATION DB
222 RESPONSE GENERATION INFORMATION DB
223 CONTENT DB
31 IMAGE
32 REQUEST INFORMATION DISPLAY SCREEN
40 CAPTURED IMAGE
42 FIELD OF VIEW
110 OUTWARD CAMERA
111 INWARD CAMERA
112 MIKE
300 REQUEST INFORMATION COLLECTION RESPONSE GENERATION UNIT
301 REQUEST CONTENTS DETERMINATION UNIT
302 PRIORITY CALCULATION UNIT
303 STEPWISE NOTIFICATION DETERMINATION UNIT
304 ABSTRACTION LEVEL DETERMINATION UNIT
305 REQUEST RESPONSE GENERATION UNIT
310 TARGET/BASIC POINT OBJECT EXTRACTION UNIT
311 TARGET/BASIC POINT OBJECT STORAGE UNIT
312 IN-VIEW OBJECT COLLATION UNIT
313 GUIDANCE INFORMATION GENERATION UNIT

1. An information processing apparatus, comprising: a control unit that
extracts a target object and a basic point object from an image corresponding to a user's field of view,
stores basic point object information on the basic point object in a storage unit,
determines whether the target object is included in an image corresponding to a current field of view when the user is guided to the target object, and
performs a process of presenting a position of the target object using the stored basic point object information when the target object is not included in an image corresponding to the current field of view.

2. The information processing apparatus according to claim 1, wherein the control unit performs control to present a position of the target object using the basic point object information by voice.

3. The information processing apparatus according to claim 2, in which the control unit presents a positional relationship between the basic point object and the target object by voice.

4. The information processing apparatus according to claim 2, wherein the control unit performs control to store three-dimensional position information of the extracted target object and basic point object in the storage unit.

5. The information processing apparatus according to claim 2, wherein the control unit performs object recognition from an image corresponding to the user's field of view, and extracts, as the target object, an object estimated to be of interest to the user based on the registered user information.

6. The information processing apparatus according to claim 2, wherein the control unit performs object recognition from an image corresponding to the user's field of view, compares the recognized object with a predetermined target object registered in advance, and extracts the target object.

7. The information processing apparatus according to claim 2, wherein the control unit performs object recognition from the image corresponding to the user's field of view and specifies an object that satisfies a predetermined condition as a basic point object.

8. The information processing apparatus according to claim 7, wherein the control unit specifies an object that is located around the target object and visually recognized by the user as a basic point object.

9. The information processing apparatus according to claim 7, wherein the control unit identifies an object that is positioned around the target object and has at least a color or size satisfying a predetermined criterion in the image corresponding to the user's field of view as a basic point object.

10. The information processing apparatus according to claim 2, wherein when a target object to be guided is in the user's field of view, the control unit performs control to clearly indicate a position of the target object by an AR image.

11. The information processing apparatus according to claim 2, further comprising: a transmission unit that transmits information on guidance of the target object to an information processing terminal possessed by the user.

12. The information processing apparatus according to claim 11, wherein the information processing terminal is a head-mounted device worn by the user.

13. The information processing apparatus according to claim 2, wherein the control unit performs control to start guidance to the target object at a timing according to a situation of the user.

14. An information processing method, comprising:
extracting, by a processor, a target object and a basic point object from an image corresponding to a user's field of view;
storing, by the processor, basic point object information on the basic point object in a storage unit;
judging, by the processor, whether the target object is included in an image corresponding to a current field of view when guiding the user to the target object; and
performing, by the processor, a process of presenting the position of the target object using the stored basic point object information when the target object is not included in the image corresponding to the current field of view.

15. A program allowing a computer to function as a control that
extracts a target object and a basic point object from an image corresponding to a user's field of view,
stores basic point object information on the basic point object in a storage unit,
judges whether the target object is included in an image corresponding to a current field of view when guiding the user to the target object, and
performs a process of presenting the position of the target object using the stored basic point object information when the target object is not included in the image corresponding to the current field of view.
